(19) United States
(12) Patent Application Publication
(10) Pub. No.: US 2015/0339058 A1
(43) Pub. Date: Nov. 26, 2015

(54) STORAGE SYSTEM AND CONTROL METHOD

(71) Applicant: HITACHI, LTD., Chiyoda-ku, Tokyo (JP)

(72) Inventors: Yoshihiro YOSHII, Tokyo (JP); Sadahiro SUGIMOTO, Tokyo (JP)

(21) Appl. No.: 14/759,989

(22) PCT Filed: Mar. 26, 2013
(86) PCT No.: PCT/JP2013/058783

§ 371 Date: Jul. 9, 2015

(51) Int. Cl. G06F 3/06

(52) U.S. Cl. CPC G06F 3/061; G06F 3/0688; G06F 3/0659

(57) ABSTRACT

A storage controller stores a data block related to a received write command in a first cache memory as an undefined state, and transmits, to a storage device, an undefining write command of requesting to store the data block as an undefined state, the undefining write command being a command associated with an address of a target logical area corresponding to a write destination according to the write command. The storage device has a non-volatile memory configured by a plurality of physical areas, stores a data block related to the undefining write command transmitted from the storage controller in an empty physical area of the plurality of physical areas, and assigns the physical area to the target logical area as a physical area in an undefined state.

### TECHNICAL FIELD

The present invention relates to technology of a storage system and a control method.

### BACKGROUND ART

There is known a storage system for duplexing a data block for writing that is received from a host and storing the same in cache memories to enhance fault tolerance on the cache memories (e.g., PTL 1). There is also known a storage system for creating a redundant data block (hereinafter referred to as “parity block”) on the basis of RAID (Redundant Arrays of Inexpensive Disks) 5 or the like and storing the same in a storage device to enhance fault tolerance on the storage device.

### CITATION LIST

### Patent Literature

[PTL 1]

Japanese Patent Application Laid-open No. H7-160432

### SUMMARY OF INVENTION

### Technical Problem

A process of writing a data block for writing in two cache memories results in increase in the I/O (Input/Output) load of the cache memories. Similarly, a process of creating a parity block can result in increase in the I/O (Input/Output) load of the cache memories. The increase in the I/O load of the cache memories may cause degradation of the response performance of a storage system.

An object of the present invention is to reduce an I/O load to cache memories.

### Solution to Problem

A storage system according to an embodiment of the present invention includes a storage controller having a first cache memory, and configured to receive a write command of a data block, and a storage device having a non-volatile memory configured by a plurality of physical areas, the storage device being configured to provide a plurality of logical areas including a target logical area corresponding to a write destination in accordance with the write command.

The storage controller is configured to store a data block related to the received write command in the first cache memory as an undefined state, and transmit, to the storage device, an undefining write command of requesting to store the data block as an undefined state, the undefining write command being a command associated with an address of the target logical area.

The storage device is configured to receive the undefining write command from the storage controller, store a data block related to the undefining write command in an empty physical area of the plurality of physical areas, and assign the physical area to the target logical area as a physical area in an undefined state.

### Advantageous Effects of Invention

According to the present invention, it is possible to reduce an I/O load to cache memories and enhance the response performance of a storage system.

### BRIEF DESCRIPTION OF DRAWINGS

FIG. 1 is a block diagram showing a whole configuration of a storage system.

FIG. 2 is a figure for illustrating a summary of a duplex process of dirty blocks.

FIG. 3 is a figure for illustrating a summary of a parity block creation process.

FIG. 4 is a block diagram showing a logical configuration of a storage area of a cache memory.

FIG. 5 is figure for illustrating configurations of a cache directory and a segment management block.

FIG. 6 is a figure for illustrating a linked list managed by queue management information.

FIG. 7 shows a data configuration example of drive configuration information.

FIG. 8 is a block diagram showing a configuration of an FMPK.

FIG. 9 shows information that the FMPK has.

FIG. 10 is a figure for illustrating the relation between logical pages and physical pages.

FIG. 11 shows a configuration example of a mapping management table.

FIG. 12 is a figure for illustrating a configuration of a dirty logical page linked list.

FIG. 13 is a flowchart of a write command reception process performed by a storage controller.

FIG. 14 is a flowchart of a write data reception process performed by the storage controller.

FIG. 15 is a flowchart of a dirty data CM & FM duplex process performed by the storage controller.

FIG. 16 is a flowchart of a dirty data CM duplex process performed by the storage controller.

FIG. 17 is a flowchart of a new parity block creation process performed by the storage controller.

FIG. 18 is a flowchart of a new parity block duplex process performed by the storage controller.

FIG. 19 is a flowchart of a dirty data defining process performed by the storage controller.

FIG. 20 is a flowchart of a read command reception process performed by an FMPK.

FIG. 21 is a flowchart of a dirty read command reception process performed by the FMPK.

FIG. 22 is a flowchart of a write command reception process performed by the FMPK.

FIG. 23 is a flowchart of a dirty write command reception process performed by the FMPK.

FIG. 24 is a flowchart of a dirty defining command reception process performed by the FMPK.

FIG. 25 is a flowchart of a dirty discard command reception process performed by the FMPK.

FIG. 26 is a figure for illustrating a dirty block duplex process performed in a case where a failure occurs on the FMPK #0.

FIG. 27 is a figure for illustrating a read command process performed by the storage controller in a case where a failure occurs on the FMPK#0.

FIG. 28 is a figure for illustrating a dirty block duplex process performed in a case where a failure occurs on the storage controller #0.

FIG. 29 is a flowchart of a process performed in a case where a failure occurs on the storage controller.

FIG. 30 is a flowchart of a dirty block confirmation command reception process performed by the FMPK.

FIG. 31 is a block diagram showing a whole configuration of a storage system according to a second embodiment.

FIG. 32 is a flowchart of a write data reception process performed by a storage controller according to the second embodiment.

### DESCRIPTION OF EMBODIMENTS

Some embodiments of a storage system for storing data blocks in cache memories and storage devices as caches will be hereinafter described with reference to the figures. In these embodiments, an FMPK (Flash Memory Package) where an FM (Flash Memory) chip serves as a storage medium is employed as each storage device. However, the storage device may be other device.

### First Embodiment

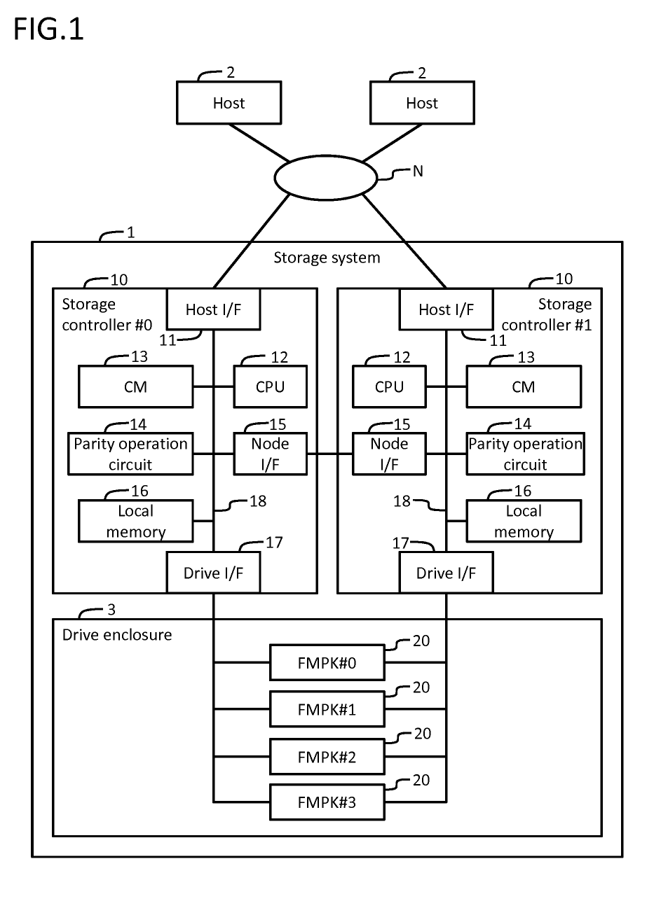

FIG. 1 is a block diagram showing a whole configuration of a storage system 1. The storage system 1 includes, for example, a storage controller 10#0, a storage controller 10#1, and a drive enclosure 3. The storage system 1 transmits/receives a data block to/from hosts 2 through a communication network N. The storage controller 10 may be one, or may be equal to or larger than two. The drive enclosure 3 may be one, or may be equal to or larger than two. Hereinafter, in a case where the storage controllers 10#0 and #1 are not distinguished, the storage controllers are simply referred to as “storage controller 10”.

The storage controllers 10 each have a host I/F (Interface) 11, a CPU (Central Processing Unit) 12, a cache memory (hereinafter referred to as “CM (Cache Memory)”) 13, a parity operation circuit 14, a node I/F 15, a local memory 16, and a drive I/F 17. Each of these elements 11 to 17 may be equal to or larger than two. These elements 11 to 17 are coupled by an internal bus 18 enabling bidirectional data transmission.

The communication networks N each are configured by, for example, a SAN (Storage Area Network). The SAN may be, for example, a Fibre Channel, an Ethernet (registered trademark) and/or an Infiniband, etc. The communication network N may be a LAN, an Internet network, or a dedicated line network, or may be combination thereof.

The hosts I/F 11 each are an I/F for coupling the communication network N and the storage controller 10. Each host I/F 11 is interposed between the communication network N and the internal bus 18, and controls the transmission/reception of data blocks. Each host I/F 11 receives an I/O (Input/Output) request from the host 2. The I/O request is associated with I/O destination information. The I/O destination information includes the ID (e.g., LUN (Logical Unit Number)) of a logical volume being an I/O destination, and the address of an I/O destination area (e.g., LBA (Logical Block Address)) in the logical volume. The I/O command is a write command or a read command.

The CPUs 12 each executes a computer program (hereinafter referred to as “program”), and implements various functions that the storage controller 10 has. The program may be stored in a non-volatile memory (not shown) in the storage controller 10, or may be stored in an external storage device, or the like. The CPU 12 transmits, to each of one or more FMPKs 20 that provide one or more logical pages corresponding to an I/O destination area identified from the I/O destination information associated with the I/O command from the host 2, an I/O command associated with the addresses of the logical pages corresponding to the I/O destination area. The I/O commands transmitted to the FMPKs 20 may be associated with the IDs (e.g., numbers) of the FMPKs 20 being the transmission destinations of the I/O commands in addition to the addresses of the logical pages.

The CMs 13 each temporarily hold (cache) a data block. Each CM 13 may be configured by a non-volatile memory. The non-volatile memory may be a flash memory, a magnetic disc memory, or the like. Alternatively, each CM 13 may have a configuration in which a volatile memory includes a backup power supply. The volatile memory may be a DRAM (Dynamic Random Access Memory), or the like. The backup power supply may be a prescribed battery. The host I/F 11, the CPU 12 and/or the drive I/F 17 may write and read a data block with respect to the CM 13 through the internal bus 17.

The node I/F 15 are I/Fs for coupling the storage controllers 10. Each node I/F 15 may be a communication network I/F such as an Infiniband, a Fibre Channel, and an Ethernet (registered trademark), or may be a bus I/F such as a PCI Express. In the storage system 1 in FIG. 1, the storage controller 10#0, and the storage controller 10#1 are coupled through the node I/Fs 15.

The drive I/Fs 17 each are an I/F for coupling the storage controller 10 and the drive enclosure 3. Each drive I/F 17 is interposed with the internal bus 17 and the FMPKs (Flash Memory Packages) 20, and controls transmission/reception of a data block. The drive I/Fs 17 each may be an I/F corresponding to a SAS, a Fibre Channel or the like. Each drive I/F 17 may transmit the data block received from the FMPK 20 to the CM 13, or may transmit the data block received from the parity operation circuit 14 to the FMPK 20.

The drive enclosure 3 has, for example, FMPKs 20#0, #1 and #2 and #3. Hereinafter, in a case where the FMPKs 20#0, #1 and #2, and #3 are not distinguished, the FMPKs are simply referred to as “FMPK 20”. Any number of the FMPKs 20 that the drive enclosure 3 has may be employed. The drive enclosure 3 may be coupled to other non-volatile memory such as an SSD (Solid State Drive) and/or an HDD (hard disk drive), in place of the FMPKs 20 or together with the FMPKs 20. Each drive I/F 17 and the FMPKs 20 may be coupled by an SAS (Serial Attached SCSI), an FC (Fibre Channel), or a SATA (Serial AT Attachment).

Each FMPK 20 in the drive enclosure 3 receives, from the storage controller 10, an I/O command (a write command or a read command) where the addresses of the logical pages provided by the FMPK 20 are designated, and performs a process according to the received I/O command.

The storage system 1 may have the drive enclosures 3 equal to or larger than two. In this case, each drive I/F 17 has a plurality of ports, and one of the drive enclosures 3 may be coupled to one of the ports of the drive I/F 17. Alternatively, the drive enclosures 3 equal to or larger than two may be coupled to one drive I/F 17 through a prescribed switch apparatus (not shown). Alternatively, the drive enclosure 3 equal to or larger than two may be coupled in cascade (in a linked state).

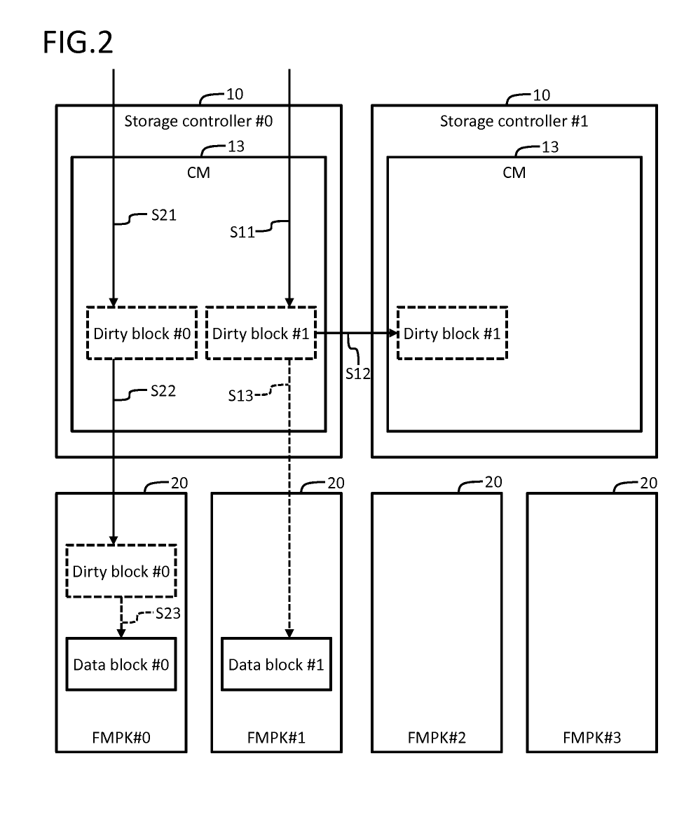

FIG. 2 is a figure for illustrating a summary of a duplex process of dirty blocks. When receiving a write command and a data block to be written (hereinafter referred to as “data block for writing”) from the host 2, the storage controller 10 stores the data block for writing in the CM 13 once, and returns a completion response to the host 2. That is, the storage controller 10 returns the completion response to the host 2 before storing the data block for writing in a corresponding FMPK 20. Generally, the write performance (write speed) of the CM 13 is higher (faster) than that of the FMPK 20, and therefore this enhances the response performance of the storage system 1 to the host 2. A data block for writing where formal write to this FMPK 20 is not completed is referred to as “dirty block”.

The storage system 1 may discard the dirty block stored in the CM 13 after the dirty block is formally written in the FMPK 20. This is because the storage system 1 can read the formally written data block from the FMPK 20.

Additionally, the storage system 1 duplexes a dirty block to hold the same in order to enhance the fault tolerance of the storage system 1. The storage system 1 according to this embodiment duplexes a dirty block by either the following first method or second method.

(First Method)

In the first method, the storage system 1 stores a dirty block in the CM 13 of the storage controller 10#0 and the CM 13 of the storage controller 10#1. A summary of a process of the storage system 1 according to the first method will be hereinafter described.

The storage controller 10#0 that receives a data block for writing stores this data block for writing in its own CM 13 as a dirty block #1 (S11). Then, the storage controller 10#0 stores this dirty block #1 also in the CM 13 of the storage controller 10#1 (S12). Consequently, the dirty block #1 is stored (duplexed) at two places of the CM 13 of the storage controller 10#0 and the CM 13 of the storage controller 10#1.

Then, the storage controller 10#0 stores the |dirty data #1, |which is [A1] stored in the CM 13, in the FMPK 20#1 as a formal data block #1 at prescribed or arbitrary timing (S13).

(Second Method)

In the second method, the storage system 1 stores a dirty block in the CM 13 and the FMPK 20. A summary of a process of the storage system 1 according to the second method will be hereinafter described.

The storage controller 10#0 that receives a data block for writing stores this data block for writing in the CM 13 as a dirty block #0 (S21). Then, the storage controller |10|[A2] writes this dirty block #0, which is stored in this CM 13, in the FMPK 20#0 as the dirty block #0 (S22). Consequently, the dirty block #0 is stored (duplexed) at two places of the CM 13 of the storage controller 10#0 and the FMPK 20#0.

Then, the storage controller 10#0 transmits a command of defining the dirty block #0 as a formal data block #0 (hereinafter referred to as “defining command”) to the FMPK 20#0 at prescribed or arbitrary timing (S23). The defining command is associated with the address of a logical page and the number of the FMPK 20. The FMPK 20 that receives this defining command changes management information on the dirty block #0 to the formal data block #0. Therefore, a data block is not copied in the FMPK 20 by this defining command.

The storage system 1 according to this embodiment has functions of both the first method and the second method, and further has a function of properly switching between the first method and the second method. However, the storage system 1 may have only the function of the second method. Alternatively, the storage system 1 may multiplex a dirty block by combining the first method and the second method.

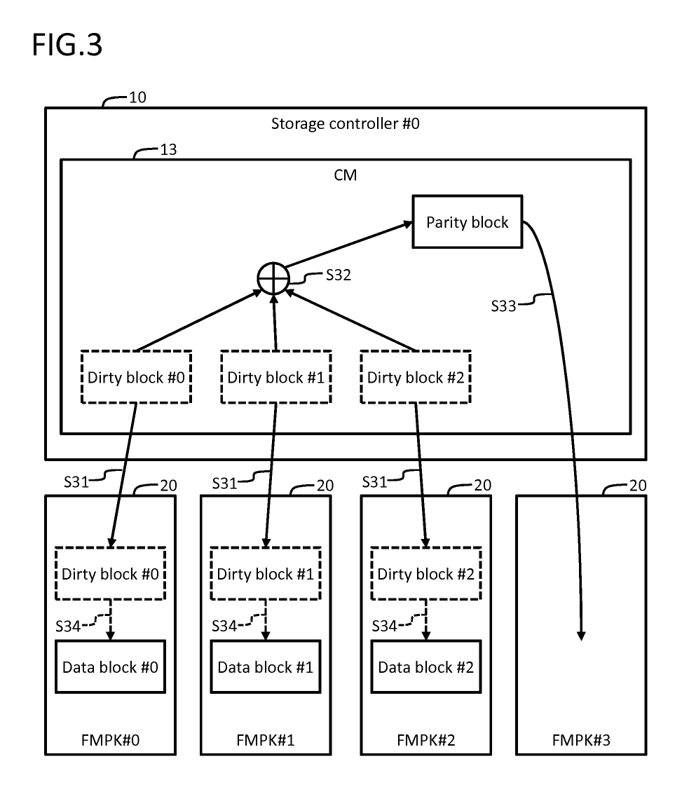

FIG. 3 is a figure for illustrating a summary of a parity block creation process. The storage system 1 gives redundancy to data to store the same in the FMPKs 20 in order to enhance the fault tolerance of the storage system 1. In RAID 5 that is a method for making data redundant, data is made redundant by data blocks equal to or larger than 2, and a parity block calculated from these data blocks. Hereinafter, a summary of the parity block creation process will be described in the light of the relation with the aforementioned second method.

In the aforementioned second method, the storage controller 10 stores dirty blocks #0, #1 and #2 in the CM 13 and the respective |FPMK|[A3] #0, #1 and #2 to duplex the dirty blocks #0, #1 and #2 (S31).

Herein, it is assumed that the storage system 1 has a configuration of 3D1P in which one parity block is created from three data blocks. In this case, the storage controller 10 has all the dirty blocks #0, #1 and #2 that satisfy a parity cycle in the CM 13, and therefore a parity block is created from the dirty blocks #0, #1 and #2 in this CM 13 (S32).

Then, the storage controller 10 writes this created parity block in the FMPK 20#3.

Next, the storage controller 10 transmits respective defining commands to the FMPKs 20#0, #1 and #2 to define the dirty blocks #0, #1 and #2 as formal data blocks #0, #1 and #2 respectively (S34). The FMPKs 20#0, #1 and #2 that receive the respective defining commands change management information on the dirty blocks #0, #1 and #2 to the formal data blocks #0, #1 and #2, respectively. Consequently, data blocks #0, #1 and #2, and the parity block corresponding to the data blocks #0, #1 and #2 are stored in the FMPKs 20#0, #1 and #2, #3.

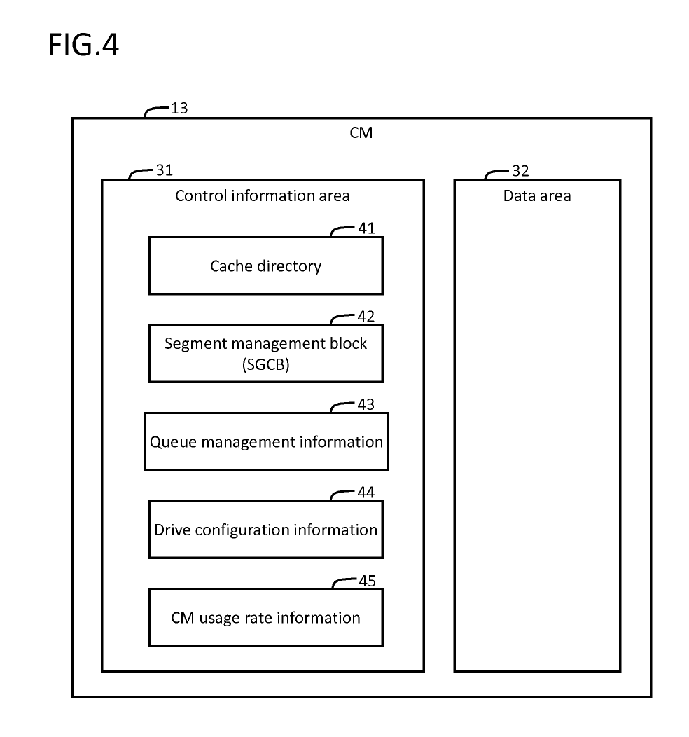

FIG. 4 is a block diagram showing a logical configuration of a storage area of the CM 13. The CM 13 has a control information area 31 and a data area 32 as the logical configuration of the storage area.

In the data area 32, data blocks are stored. In the data area 32, data blocks for writing transmitted from the hosts 2 may be cached as dirty blocks. In the data area 32, data blocks read from the FMPKs 20 may be cached as clean blocks (the meaning of “clean” will be later described).

In the control information area 31, information for controlling the data area 32 is stored. In the control information area 31, a cache directory 41, a segment management block 42, queue management information 43, a drive configuration information 44, and CM usage rate information 45 are stored. Hereinafter, “segment management block” is sometimes referred to as “SGCB (Segment Control Block)”. These pieces of information 41 to 45 are sometimes collectively referred to as “control information”.

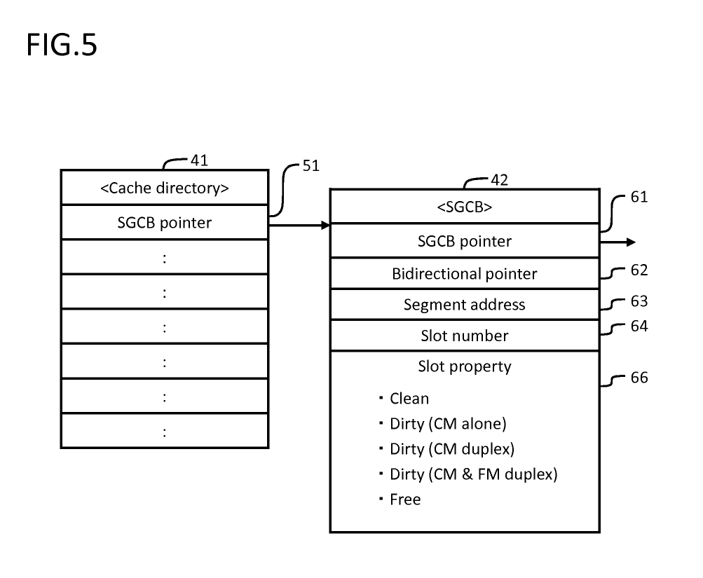

The cache directory 41 has information for managing the SGCB 42. The SGCB 42 has information for managing the data area 32 of the CM 13. The cache directory 41, the SGCB 42, and an SGCB pointer 51 will be later described in detail (see FIG. 5).

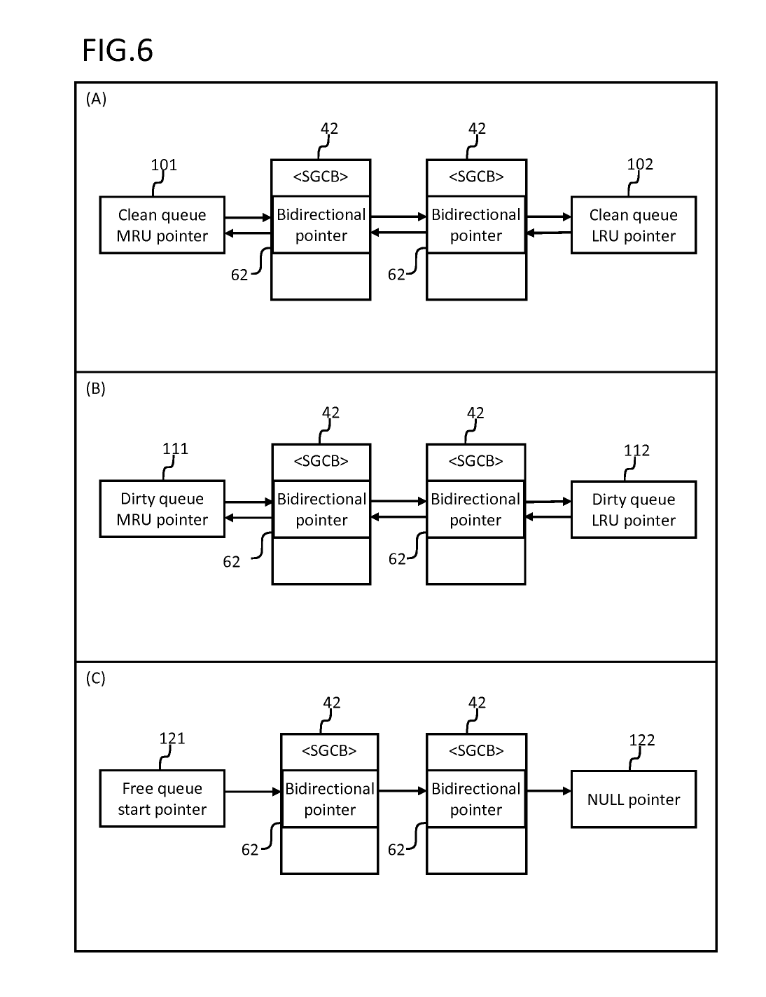

The queue management information 43 has information for managing a prescribed SGCB 42 as a cue. The queue management information 43 will be later described in detail (see FIG. 6).

The drive configuration information 44 has information on the configurations and types of the storage devices (FMPKs 20, etc.) that provide logical volumes, and the drive configuration information 44 may have information indicating the positions of the FMPKs 20 in the drive enclosure 3. The drive configuration information 44 may have information on the relation between the logical volumes provided by the FMPKs 20, and logical volumes assigned to the hosts 2.

The CM usage rate information 45 has information on the usage rate of the CM 13 (hereinafter referred to as “CM usage rate”). The CM usage rate may be the input/output amount of data per prescribed time of the internal bus 18 with respect to the CM 13 (or the number of input/output of data blocks). The CPU 12 may measure the input/output amount of the internal bus 18 with respect to the CM 13 to calculate the CM usage rate on the basis of the measurement result. The CPU 12 may calculate the CM usage rate on the basis of the following formula.

CM usage rate=(clock number per prescribed time assigned to a data transfer process to the CM 13)/(total clock number per prescribed time)×100[%]

The aforementioned prescribed time may be elapsed time from a time point when the CPU 12 starts measurement, or may be unit time.

FIG. 5 is a figure for illustrating configurations of the cache directory 41 and the SGCB 42. The cache directory 41 has the SGCB pointer 51 equal to or larger than one. The cache directory 41 may manage a plurality of the SGCB pointers 51 as a hash table.

The SGCB pointer 51 stores an address indicating a prescribed SGCB 42. The SGCB pointer 51 may have the correspondence relation with LBA (Logical Block Address). That is, the storage controller 10 may identify the SGCB pointer 51 from the LBA to identify the SGCB 42 from the specified SGCB pointer 51. The LBA may be published to external apparatuses such as the hosts 2.

The read command/write command transmitted from the host 2 may include the LBA indicating the position of read/write of a data block. When receiving the read command/write command, the storage controller 10 may reads/writes the data block as follows. That is, the storage controller 10 identifies, from the cache directory 41, an SGCB pointer 51 corresponding to the LBA included in the read command/write command. Then, the storage controller 10 identifies an SGCB 42 indicated by the identified SGCB pointer 51. Thus, the storage controller 10 identifies an SGCB 42 corresponding to the LBA.

The SGCB 42 has a next SGCB pointer 61, a bidirectional pointer 62, a segment address 63, a slot number 64, and a slot property 66.

The next SGCB pointer 61 stores an address indicating the next SGCB 42. The bidirectional pointer 62 stores an address of other SGCB 42 located in front and back of a linked list configured by the SGCBs 42. The details of the linked list will be described later (see FIG. 6). The segment address 63 stores an address indicating a segment corresponding to the SGCB 42. The slot number 64 stores an address of a logical volume of a segment corresponding to the SGCB 42.

The slot property 66 stores information indicating which property the segment corresponding to the SGCB 42 is among the following properties (A) to (E) (hereinafter referred to as “property information”).

(A) Clean

The “clean” indicates that a data block stored in a segment corresponding to the SGCB 42 is already stored in the FMPK 20 as a formal data block. Such a data block is sometimes referred to as “clean block”. The clean block is already formally stored in the FMPK 20, and therefore if the clean block is deleted from the CM 13, a failure does not occur.

(B) Dirty (CM Alone)

The “dirty (CM alone)” indicates that the data block stored in the segment corresponding to the SGCB 42 is not yet formally stored in the FMPK 20 and is not duplexed. The dirty block is not yet formally stored in the FMPK 20 as a formal data block, and therefore if the dirty block is deleted from the CM 13, a failure occurs. The following is also similar.

(C) Dirty (CM Duplex)

The “dirty (CM duplex)” indicates that the data block stored in the segment corresponding to the SGCB 42 is not yet formally stored in the FMPK 20, and is stored (duplexed) at two locations of the CM 13 of the storage controller 10#0 and the CM 13 of the storage controller 10#1, which corresponds to the aforementioned first method.

(D) Dirty (CM & FM Duplex)

The “dirty (CM & FM duplex)” indicates that the data block stored in the segment corresponding to the SGCB 42 is not yet formally stored in the FMPK 20, and is stored (duplexed) at two locations of the CM 13 of the storage controller 10#0 or #1 and the FMPK 20, which corresponds to the aforementioned second method.

(E) Free

The “free” indicates that a data block is not stored in the segment corresponding to the SGCB 42, and it is possible to write. Herein, in the aforementioned (A) to (E), “a data block is not formally stored in the FMPK 20” means that a physical page for storing a data block is managed as a dirty physical page. More specifically, it means a state where a value of a dirty physical page number 303 associated with a logical page number 301 corresponding to the data block is not managed as a physical page number 302, in a mapping management table 81. On the other hand, “a data block is formally stored in the FMPK 20” means that the physical page for storing a data block is managed as a physical page other than the dirty physical page. More specifically, it means a state where the value of the dirty physical page number 303 is managed as the physical page number 302. Additionally, a state of managing as a normal physical page (the physical page that stores the data block is the physical page other than the dirty physical page or the physical page number 302) is also referred to as a defined state, and a state of managing as the dirty physical page (physical page number 303) is referred to as an undefined state.

FIG. 6 is a figure for illustrating the linked list managed by the queue management information 43. The queue management information 43 has information for managing (A) clean queue linked list, (B) dirty queue linked list, and (C) free queue linked list. Hereinafter, the linked lists (A) to (C) will be described.

(A) Clean Cue Linked List

In the clean queue linked list, SGCBs 42 where the slot property 66 is “clean” are linked.

A |clean queue MRU (Most Recently Used) pointer 10 |[A4] is linked at the head of the clean queue linked list, and a clean queue LRU (Least Recently Used) pointer 102 is linked at the end thereof. The clean queue MRU pointer 101 stores an address indicating an SGCB 42 linked at the back of the clean queue MRU pointer 101. The clean queue LRU pointer 102 stores an address indicating an SGCB 42 linked at the front of the clean queue LRU pointer 102. The clean queue MRU pointer 101 and the clean queue LRU pointer 102 are managed by the queue management information 43.

In the clean queue linked list, the SGCB 42 closer to the clean queue MRU pointer 101 is the SGCB 42 of a clean block where the access (utilization) date and time is new, and the SGCB 42 closer to the clean queue LRU pointer 102 is the SGCB 42 of a clean block where the access (utilization) date and time is old. For example, when a certain clean block is accessed (utilized), an SGCB 42 corresponding to this clean block is linked just behind the clean queue MRU pointer 101 in the clean queue linked list. The SGCBs 42 are bidirectionally linked by the bidirectional pointers 62.

Therefore, the storage controller 10 identifies the clean queue MRU pointer 101 (or the clean queue LRU pointer 102) in reference to the queue management information 43 to trace the linked list from this, so that the SGCB 42 of the clean block where the access (utilization) date and time is new (or old) can be traced in order.

(B) Dirty Queue Linked List

In the dirty queue linked list, SGCBs 42 where the slot property 66 is “dirty” are linked.

A dirty queue MRU pointer 111 is linked at the head of the dirty queue linked list, and a dirty queue LRU pointer 112 is linked at the end thereof. The dirty queue MRU pointer 111 stores an address indicating an SGCB 42 linked at the back of the dirty queue MRU pointer 111. The dirty queue LRU pointer 112 stores an address indicating an SGCB 42 linked at the front of the dirty queue LRU pointer 112.

The |dirty queue MRU pointer 1111 |[A5] and the dirty queue LRU pointer 112 are managed by the queue management information 43.

In the dirty queue linked list, the SGCB 42 closer to the dirty queue MRU pointer 111 is the SGCB 42 of a dirty block where the access (utilization) date and time is new, and the SGCB 42 closer to the dirty queue LRU pointer 112 is the SGCB 42 of a dirty block where the access (utilization) date and time is old. For example, when a certain dirty block is accessed (utilized), an SGCB 42 corresponding to this dirty block is linked just behind the dirty queue MRU pointer 111 in the dirty queue linked list. The SGCBs 42 are bidirectionally linked by the bidirectional pointers 62.

Therefore, the storage controller 10 identifies the |dirty queue MRU pointer 1111 (or the dirty queue LRU pointer 1112) |[A6] in reference to the queue management information 43 to trace the linked list from this, so that the SGCB 42 of the dirty block where the access (utilization) date and time is new (or old) can be traced in order.

(C) Free Queue Linked List

In the free queue linked list, SGCBs 42 where the slot property 66 is “free” are linked.

A free queue start pointer 121 is linked at the head of the free queue linked list, and a NULL pointer 122 is linked at the end thereof. The free queue start pointer 121 stores an address indicating an SGCB 42 linked at the back of the free queue start pointer 121.

The free queue start pointer 121 is managed by the queue management information 43. For example, when a certain data block is deleted and the segment thereof becomes free, an |SGCC |[A7] corresponding to this segment is linked just in front of the NULL pointer 122. The SGCBs 42 are linked by the bidirectional pointers 62 in one direction (unidirectionally).

Therefore, the storage controller 10 identifies the free queue start pointer 121 in reference to the queue management information 43 to trace the linked list from this, so that the SGCB 42 of free can be traced in order.

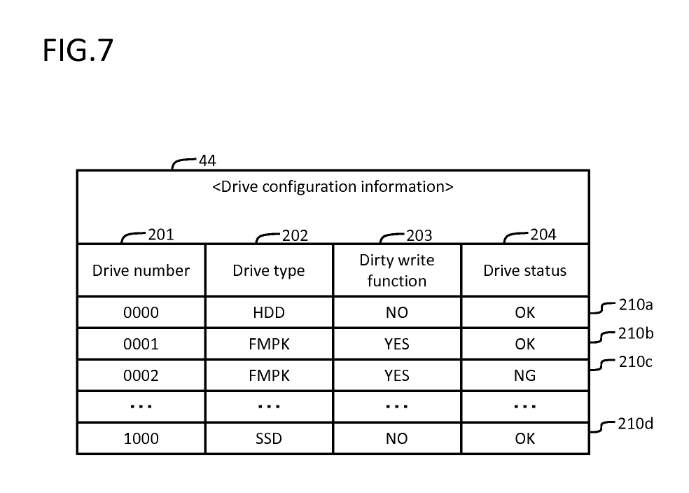

FIG. 7 shows a data configuration example of the drive configuration information 44. The drive configuration information 44 has information on drives (FMPKs 20, etc.) that the drive enclosure 3 has. The items of the drive configuration information 44 are a drive number 201, a drive type 202, a dirty write function 203, and a drive status 204.

The drive number 201 stores numbers capable of identifying the drives in the drive enclosure 3. For example, the drive number 201 stores IDs uniquely assigned to the drives.

The drive type 202 stores information enabling identification of the types of the drives. For example, the types of the drives such as an HDD, an SSD, and an FMPK are stored.

The dirty write function 203 stores information indicating whether or not the drives each correspond to the dirty write function 203. For example, in a case where the drive corresponds to the dirty write function 203, “YES” is stored. In a case where the drive does not correspond to the dirty write function 203, “NO” is stored. The drive corresponding to the dirty write function 203 has the following functions (A) and (B).

(A) A function of holding a data block previously mapped to a logical page until a dirty block is mapped to the logical page as a formal data block (hereinafter referred to as “old data block”). This is because in a case where the storage controller 10 creates a parity block by read-modify-write, an old data block is required.

(B) A function of mapping a dirty block to a logical page as a formal data block (i.e., a function that corresponds to a defining command). Consequently, the storage controller 10 can store the dirty block in the drive as the formal data block without newly writing the dirty block on the CM 13 in the drive.

The drive status 204 stores information indicating whether or not a drive normally operates. For example, in a case where the drive normally operates, “OK” is stored. In a case where any abnormality occurs, “NG” is stored.

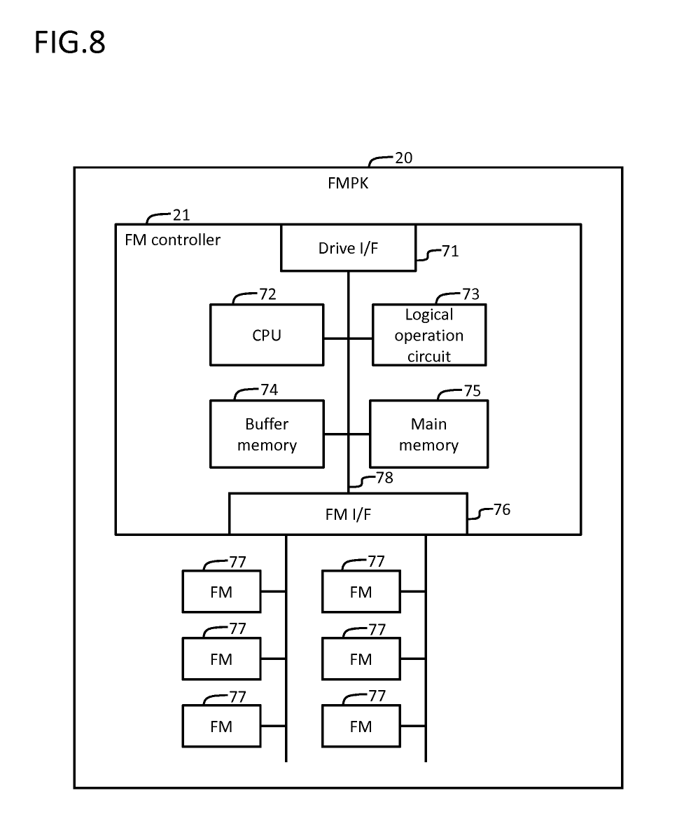

FIG. 8 is a block diagram showing a configuration of the FMPK 20. The FMPK 20 has an FM controller 21, FMs (Flash Memories) 77 equal to or larger than one.

The FM controller 21 has a drive I/F 71, a CPU 72, a logical operation circuit 73, a buffer memory 74, a main memory 75, and an FM I/F 76. These elements 71 to 76 each may be equal to or larger than two. These elements 71 to 76 are coupled by an internal bus 78 capable of bidirectionally transmitting/receiving data.

The drive I/F 71 intermediates data transmission/reception between the inside of the FM controller 21 and the storage controller 10. The drive I/F 71 is an interface corresponding to an SAS or a Fibre Channel, and may be coupled to the drive I/F 17 of the storage controller 10.

The logical operation circuit 73 has a function of calculating a parity block, an intermediate parity block, or the like. The logical operation circuit 73 may have a function of performing, for example, compression, extension, encryption and/or decryption.

The CPU 72 executes a prescribed program to implement various functions that the FM controller 21 has. The program may be stored in an internal non-volatile memory (not shown), or may be stored in an external storage apparatus.

The main memory 75 holds various programs and data blocks used by the CPU 72 and/or the logical operation circuit 73 during the execution. The main memory 75 is configured by, for example, a DRAM, etc.

The buffer memory 74 buffers data blocks, etc. written/read in the FMs 77. The buffer memory 74 is configured by, for example, a DRAM, etc. The |main memory 314 and the buffer memory 315 |[A8] may be physically configured as the same memory.

The FM I/F 76 intermediates data block transmission/reception between the inside of the FM controller 21 and the FMs 77.

The FMs 77 each are a non-volatile memory chip, and have a function of holding a data block. Each FM 77 may be a flash memory chip, or may be other non-volatile memory chip such as a PRAM (Phase change RAM) chip, an MRAM (Magnetoresistive RAM) chip, and a ReRAM (Resistance RAM) chip.

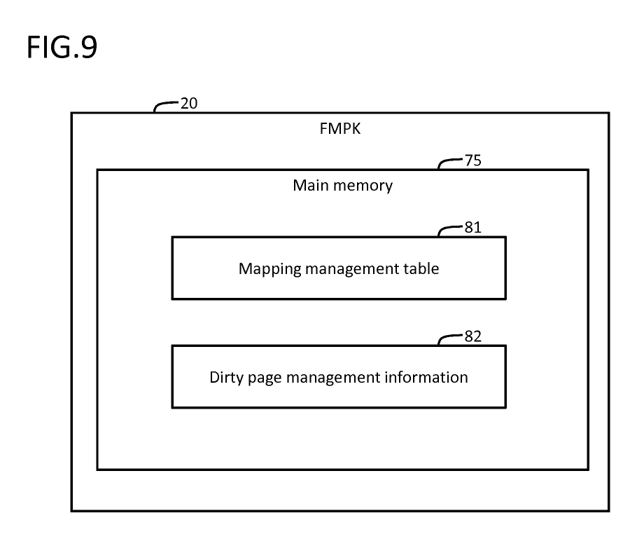

FIG. 9 shows information that the FMPK 20 has. The FMPK 20 has the mapping management table 81, and dirty page management information 82.

The mapping management table 81 manages the correspondence relation between logical pages being logical pages provided by the FMPK 20, and physical pages indicating actual storage areas (segments) of the FM 77. The relation between the logical pages and the physical pages will be now described with reference to the figure.

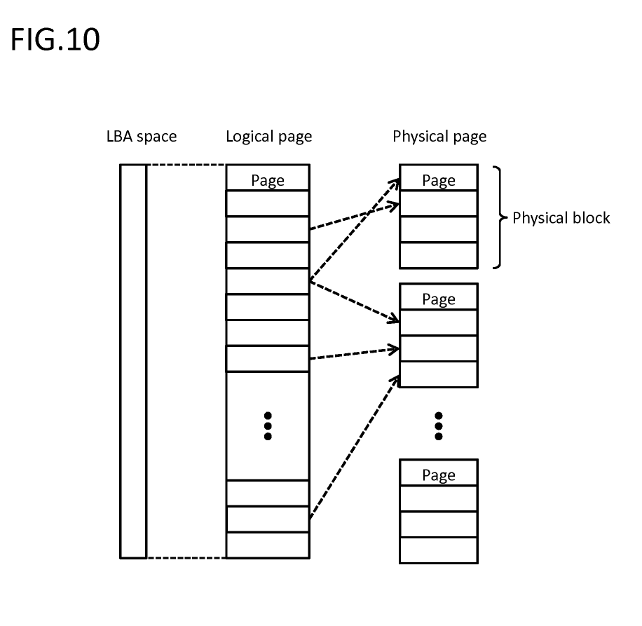

FIG. 10 is a figure for illustrating the relation between the logical pages and the physical pages. The FMPK 20 divides the storage area of the FM 77 into units referred to as a physical page to manage the same. The FMPK 20 collects the prescribed number of the physical pages in a unit referred to as a physical block. The FMPK 20 maps the physical page to the logical page to manage these. The mapping management table 81 manages the correspondence relation (mapping) between the physical pages and the logical pages.

In a case of a NAND-type flash memory, writing and reading can be generally performed in a physical page unit, but deleting can be performed only in a physical block unit. Therefore, in a case where the writing of a new data block occurs in a logical page corresponding to a physical page where a data block is already stored, the new data block cannot be overwritten on the physical page where the data block is already stored. Accordingly, the FMPK 20 stores the new data block in a free physical page, and maps a logical page to the physical page where the new data block is stored, in the mapping management table 81. In the case of the NAND-type flash memory, the data block is thus overwritten on the logical page.

The NAND-type flash memory limits (has a lifetime in) the number of times of rewriting per storage areas related to a physical block. Therefore, the FM controller 21 moves a data block stored in a certain physical page to other physical page at prescribed or arbitrary timing such that the same physical block is not rewritten with high frequency. Additionally, the FM controller 21 deletes an unnecessary data block stored in the physical block at prescribed or arbitrary timing. Such a process is referred to as reclamation. The FMPK 20 may update the mapping management table 81 with the movement of the data block by reclamation, or the like.

The FMPK 20 may manage the correspondence relation between the logical pages and the LBA. The FMPK 20 may publish this LBA space to the storage controller 10. That is, the storage controller 10 may designate the LBA to request the reading and writing of the data block.

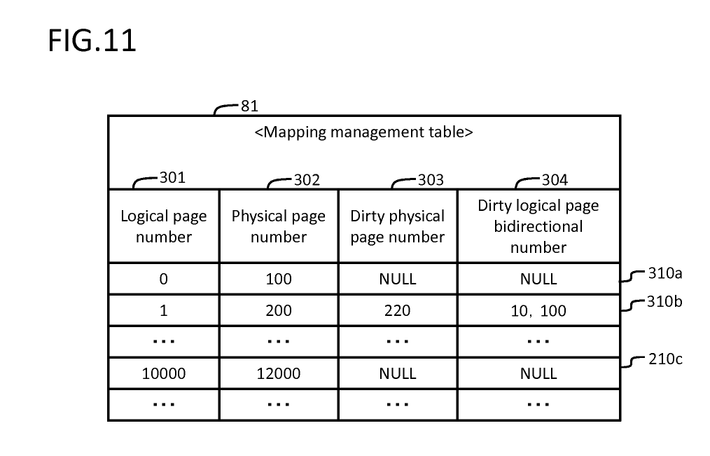

FIG. 11 shows a configuration example of the mapping management table 81. The items of the mapping management table 81 are the logical page number 301, the physical page number 302, the dirty physical page number 303, and a dirty logical page bidirectional number 304.

The logical page number 301 stores numbers for identifying logical pages, etc. The physical page number 302 stores numbers for identifying physical pages, etc. Therefore, the logical page number 301 and the physical page number 302 in a record 310a, etc. show the aforementioned correspondence relation between the logical page and the physical page.

The dirty physical page number 303 stores the physical page number 302 of physical pages where dirty blocks are stored (hereinafter referred tows “dirty physical page”). That is, the physical pages shown by the physical page number 303 are stored in the dirty blocks. Therefore, the record 310a and the like in the mapping management table 81 show the correspondence relation among the logical pages, the physical page, and the dirty physical pages. In a case where no dirty physical page corresponding to a logical page exists, “NULL” is stored in the dirty physical page number 303.

That is, two of a physical page and a dirty physical page can be mapped to one logical page. In a case where a dirty physical page is mapped to a logical page, a dirty block stored in this dirty physical page is eventually defined as a formal data block (i.e., formal physical page) of this logical page. For example, in a case where the FMPK 20 receives a defining command from the storage controller 10, values stored in one or a plurality of dirty physical page numbers 303 where dirty blocks are moved to physical page numbers 302 having the correspondence relation with the dirty physical page numbers 303 on the mapping management table 81, and these dirty physical page numbers 303 become “NULL”, thereby defining the dirty blocks as formal data blocks.

The dirty logical page bidirectional number 304 is used in a case where a dirty logical page linked list is configured. The dirty logical page linked list will be now described with reference to the figure.

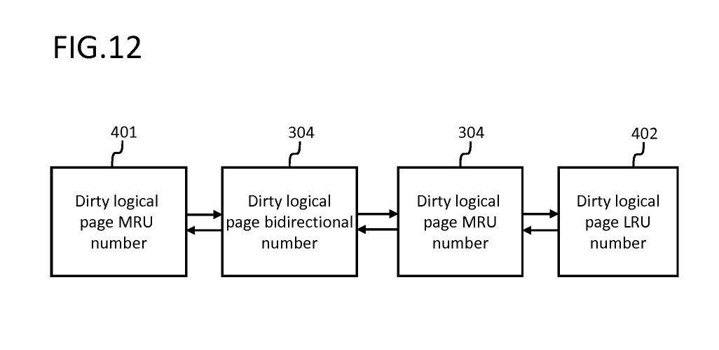

FIG. 12 is a figure for illustrating a configuration of the dirty logical page linked list. In the dirty logical page linked list, logical pages that store dirty blocks are linked.

A dirty logical page MRU number 401 is linked at the head of the dirty logical page linked list, and a dirty logical page LRU number 402 is linked at the end thereof. The dirty logical page MRU number 401 stores the logical page number 301 of a logical page linked at the back of the dirty logical page MRU number 401. The dirty logical page LRU number 402 stores the logical page number 301 of a logical page linked at the front of the dirty logical page LRU number 402. Then, the logical pages are bidirectionally linked to other logical page by the dirty logical page bidirectional numbers 304 of the mapping management table 81 shown in FIG. 11. The dirty logical page MRU number 401 and the dirty logical page LRU number 402 are managed by the dirty page management information 82.

In the dirty logical page linked list, the logical page closer to the dirty logical page MRU number 401 indicates a dirty block where the access (utilization) date and time is new, the logical page closer to the dirty logical page LRU number indicates a dirty block where the access (utilization) date and time is old. For example, when a dirty physical page is mapped to a certain logical page, this logical page is linked right behind the dirty logical page MRU number.

The FM controller 21 can identify the logical page mapped to the dirty physical page by reference of this dirty logical page linked list, without searching all records in the mapping management table 81. That is, the FM controller 21 can effectively search the dirty physical pages by reference of this dirty logical page linked list.

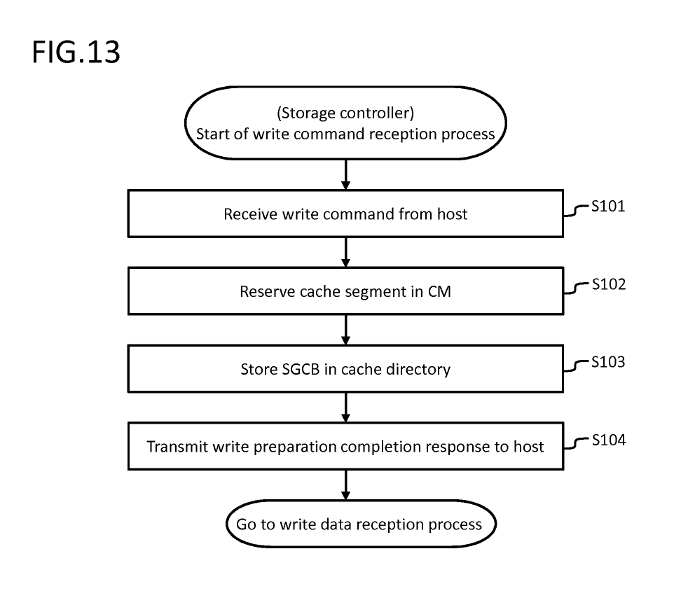

FIG. 13 is a flowchart of a write command reception process performed by the storage controller 10. The main component of the process is the storage controller 10 in the following description, but may be the CPU 12 that the storage controller 10 has.

When receiving a write command from the host 2 (S101), the storage controller 10 performs the following processes. The write command may include an LBA indicating a write destination.

The storage controller 10 reserves a cache segment for storing a data block for writing related to the write command on the CM 13 (S102).

The storage controller 10 create an SGCB 42 corresponding to the reserved cache segment to store the same in the cache directory 41 (S103).

When entering a state where the cache segment can be normally reserved, and the data block for writing can be received, the storage controller 10 transmits a response of completion of write preparation to the host 2 (S104). Then, the storage controller 10 proceeds to a next write data reception process.

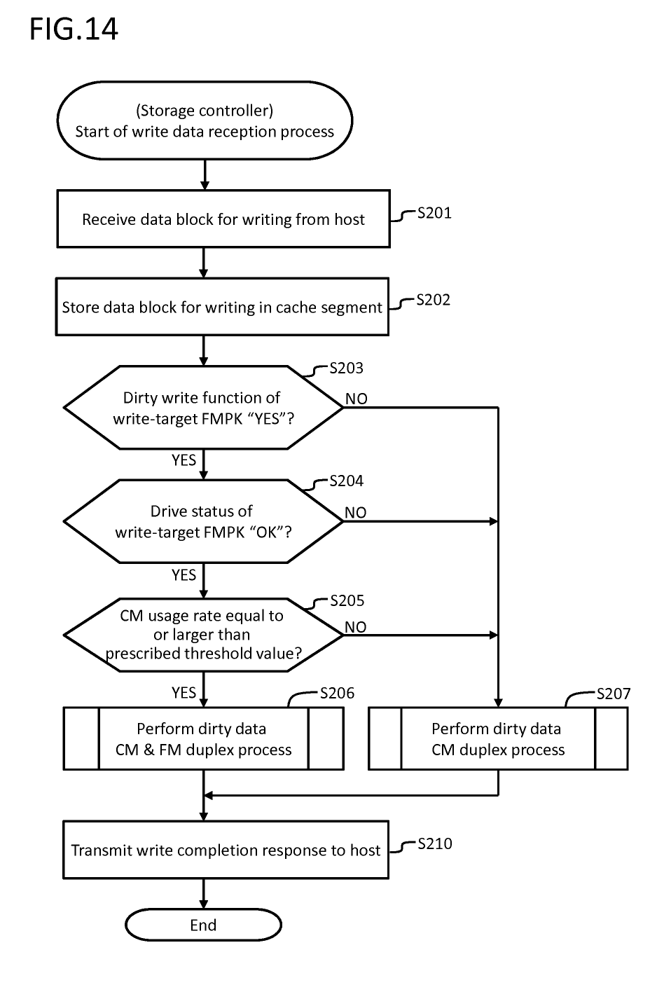

FIG. 14 is a flowchart of the write data reception process performed by the storage controller 10.

When receiving the data block for writing from the host 2 (S201), the storage controller 10 performs the following process.

The storage controller 10 stores the data block for writing in the cache segment reserved in Step S102 (S202).

The storage controller 10 determines whether or not the dirty write function 203 of a target drive of “write” is “YES” in reference to the dirty write function 203 in the drive configuration information 44 (S203). Herein, it is assumed that the target drive is the FMPK 20.

In a case where the dirty write function 203 of the FMPK 20 is “YES” (S203: YES), the storage controller 10 determines whether or not the drive status 204 of the FMPK 20 is “OK” in reference to the drive status 204 in the drive configuration information 44 (S204).

In a case where the drive status 204 of the FMPK 20 is “OK” (S204: YES), the storage controller 10 determines whether or not the CM usage rate is equal to or larger than a prescribed threshold value in reference to the CM usage rate information 45 (S205).

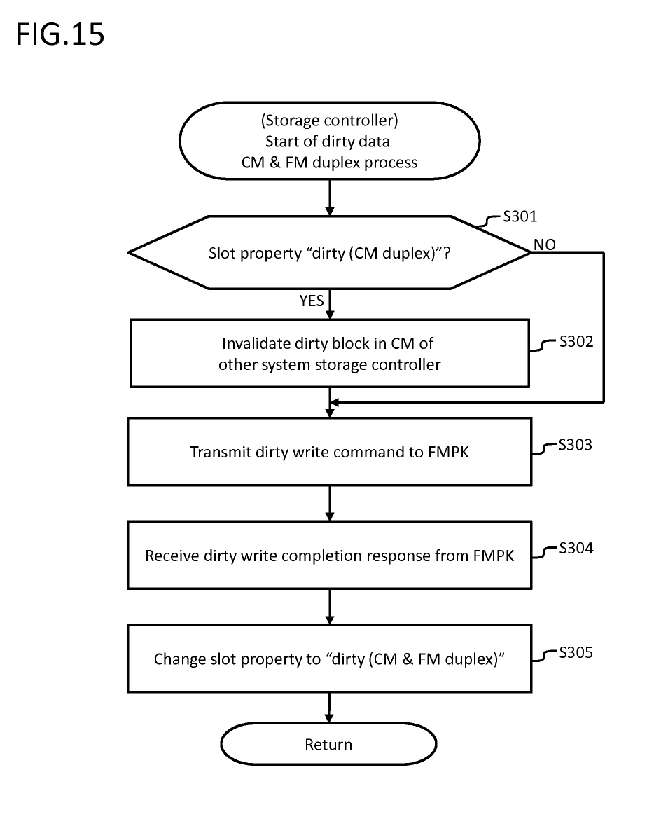

In a case where the CM usage rate is equal to or larger than the prescribed threshold value (S205: YES), the storage controller 10 decides that the data block for writing is cached at two places of the CM 13 and the FMPK 20 (CM & FM duplex), and performs a “dirty data CM & FM duplex process” (S206). The “dirty data CM & FM duplex process” will be later described in detail (see FIG. 15). Then, the storage controller 10 returns a completion response to the write command to the host 2 (S210), and terminates the process.

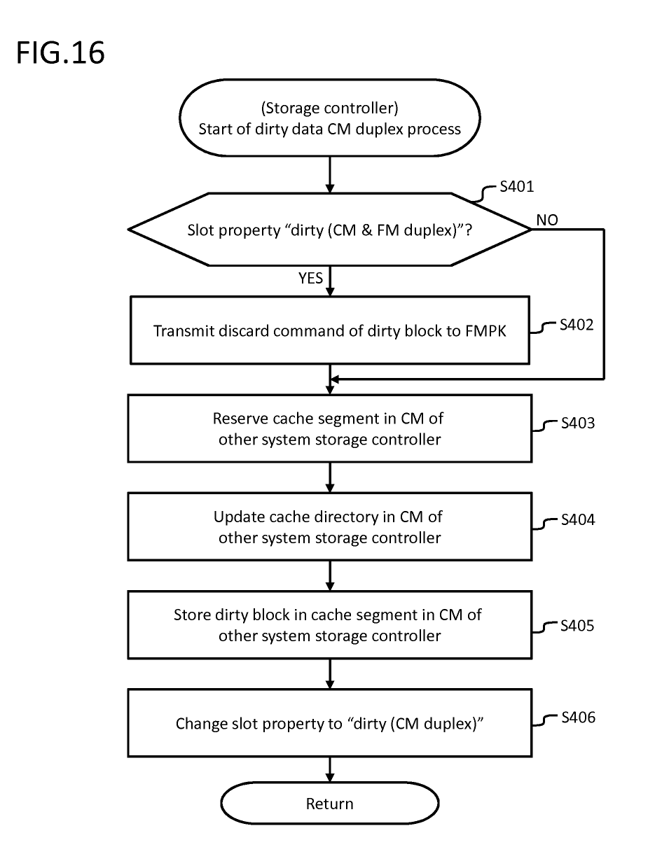

On the other hand, in a case where the dirty write function 203 of the FMPK 20 is “NO” (S203: NO), in a case where the drive status 204 of the FMPK 20 is “NO” (S204: NO), or in a case where the CM usage rate is less than the prescribed threshold value (S205: NO), the storage controller 10 decides that the data block for writing is cached at two places of a self-system CM 13 and other system CM 13 (CM duplex), and performs a “dirty data CM duplex process” (S207). The “dirty data CM duplex process” will be later described in detail (see FIG. 16). Then, the storage controller 10 returns a completion response of the write process of the data block for writing to the host 2 (S210), and terminates the process.

Through the above process, the storage system 1 can properly switch between the “CM duplex process” and the “CM & FM duplex process” on the basis of the load of the input/output amount of data with respect to the CM 13. That is, the storage system 1 determines to perform the “CM duplex process” in a case where the load of the input/output amount of the data with respect to the CM 13 is relatively small, while determining to perform the “CM & FM duplex process” in a case where the load of the input/output amount of the data with respect to the CM 13 is relatively large. Consequently, the storage controller 10 can reduce a response delay to the host 2 that can be caused in a case where the load of the input/output amount of the data with respect to the CM 13 is relatively large.

FIG. 15 is a flowchart of the dirty data CM & FM duplex process performed by the storage controller 10.

The storage controllers 10 determines whether or not the slot property 66 is “dirty (CM duplex)” in reference to the slot property 66 of an SGCB 42 corresponding to the cache segment of a process target (S301). In a case where the slot property 66 is not the “dirty (CM duplex)” (S301: NO), the storage controller 10 proceeds to Step S303.

In a case where the slot property 66 is the “dirty (CM duplex)” (S301: YES), the storage controller 10 invalidates a dirty block cached in a CM 13 of other system storage controller 10 (S302), and proceeds to Step S303. Consequently, the other system storage controller 10 can be prevented from wrongly referring to an old dirty block on the CM 13.

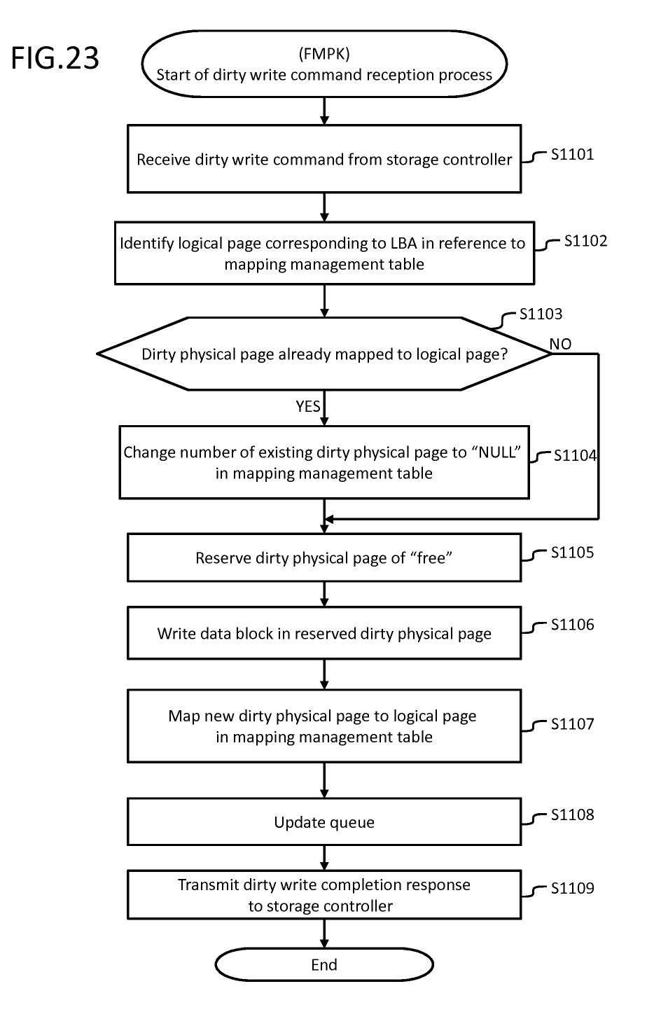

Next, the storage controller 10 transmits a dirty write command to the FMPK 20 to request to write a data block for writing on the CM 13 (dirty block) as a dirty block (S303). This is because the dirty block is stored (duplexed) at two places of the CM 13 and the FMPK 20. The dirty write command may be associated with the address of a logical page and the number of the FMPK 20. A process performed by the FMPK 20 that receives the dirty write command will be described later (see FIG. 23).

When the storage controller 10 receives a completion response of the dirty write command from the FMPK 20 (S304), the slot property 66 of the SGCB 42 is changed to “dirty (CM duplex)” (S305), and the process returns to Step S206 and the subsequent steps in FIG. 14

FIG. 16 is a flowchart of the dirty data CM duplex process performed by the storage controller 10.

The storage controller 10 determines whether or not the slot property 66 is “dirty (CM & FM duplex)” in reference to the slot property 66 of an SGCB 42 corresponding to a cache segment of a process target (S401). Ina case where the slot property 66 is not “dirty (CM & FM duplex)” (S301: NO), the storage controller 10 proceeds to Step S403.

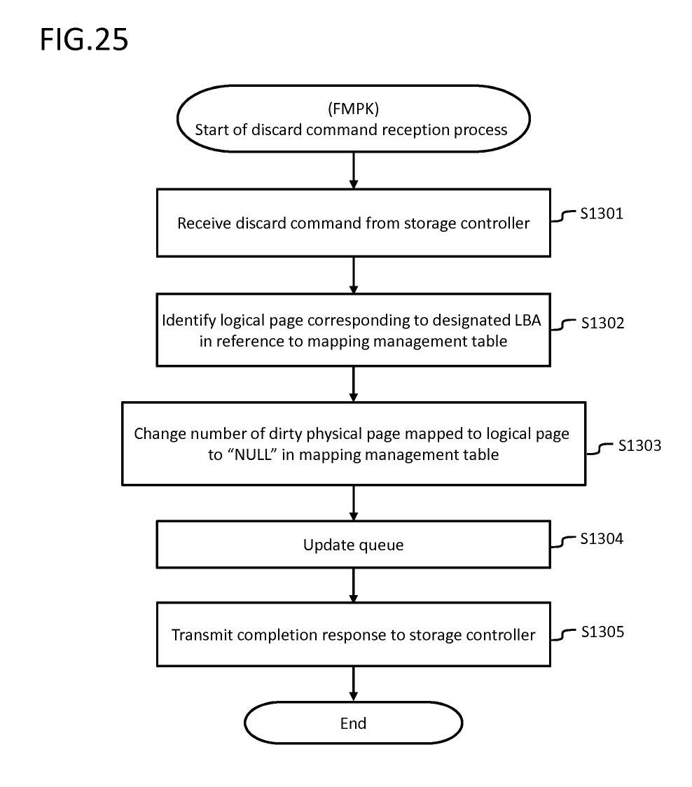

In a case where the slot property 66 is “dirty (CM & FM duplex)” (S401: YES), the storage controller 10 transmits a dirty discard command to the FMPK 20 to request to discard a dirty block corresponding to an LBA included in the command (S402). The dirty discard command may be associated with the address of a logical page and the number of the FMPK 20. The FMPK 20 that receives the dirty discard command discards the correspondence relation between a logical page corresponding to the LBA and a dirty physical page. The details of this process will be described later (see FIG. 25). Consequently, a self-system or other system storage controller 10 can be prevented from wrongly referring to an old dirty block on the FMPK 20.

Next, the storage controller 10 reserves a cache segment in the CM 13 of the other system storage controller 10 (S403).

The storage controller 10 updates the cache directory 41 of the other system storage controller 10 (S404). That is, the storage controller 10 creates an SGCB 42 corresponding to the reserved cache segment to store the SGCB 42 in the cache directory 41.

The storage controllers 10 writes a dirty block stored in the CM 13 of the self-system storage controller 10 in the cache segment reserved in the CM 13 of the other system storage controller 10 (S405). Consequently, the dirty block is duplexed in the self-system CM 13 and the other system CM 13.

The storage controller 10 changes the slot property 66 of the SGCB 42 to “dirty (CM duplex)” (S406), and returns to Step S207 and the subsequent steps in FIG. 14.

At this stage, the dirty block is duplexed. This dirty block is finally stored in the FM 77 as a formal data block to be made redundant by RAID 5, etc.

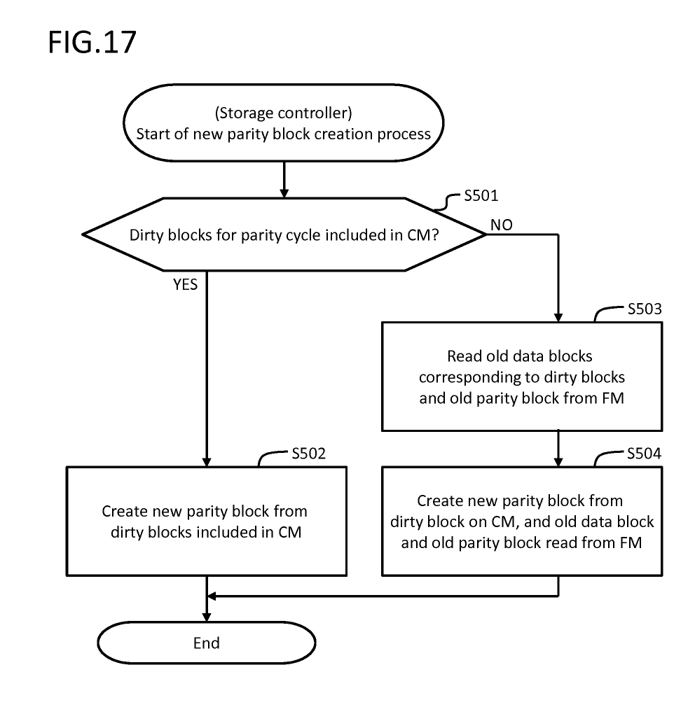

FIG. 17 is a flowchart of a new parity block creation process performed by the storage controller 10.

The storage controller 10 determines whether or not the CM 13 has dirty blocks for a parity cycle (S501). That is, the storage controller 10 determines whether or not the dirty blocks stored in the CM 13 enable a full stripe write process.

In a case where the CM 13 has the dirty blocks for a parity cycle (S501: YES), the storage controller 10 creates a new parity block (hereinafter referred to as “new parity block”) from the dirty blocks on the CM 13 by utilizing the parity operation circuit 14 (S502), and terminates the process.

In a case where the CM 13 has the dirty blocks for a parity cycle (S501: NO), the storage controller 10 reads data blocks corresponding to the dirty blocks, which are already stored in the FM 17 (hereinafter referred to as “old parity block”), and a parity block which is already stored in the FM17 (hereinafter referred to as “old parity block”) from the FM 17 (S503).

Then, the storage controller 10 creates a new parity block from the dirty blocks on the CM 13, the old data blocks and the old parity block by utilizing the parity operation circuit 14 (S504), and terminates the process. That is, in a case where the full stripe write process is not enabled, the storage controller 10 performs a read-modify-write process.

The storage controllers 10 may perform a new parity block duplex process shown below after this new parity block creation process.

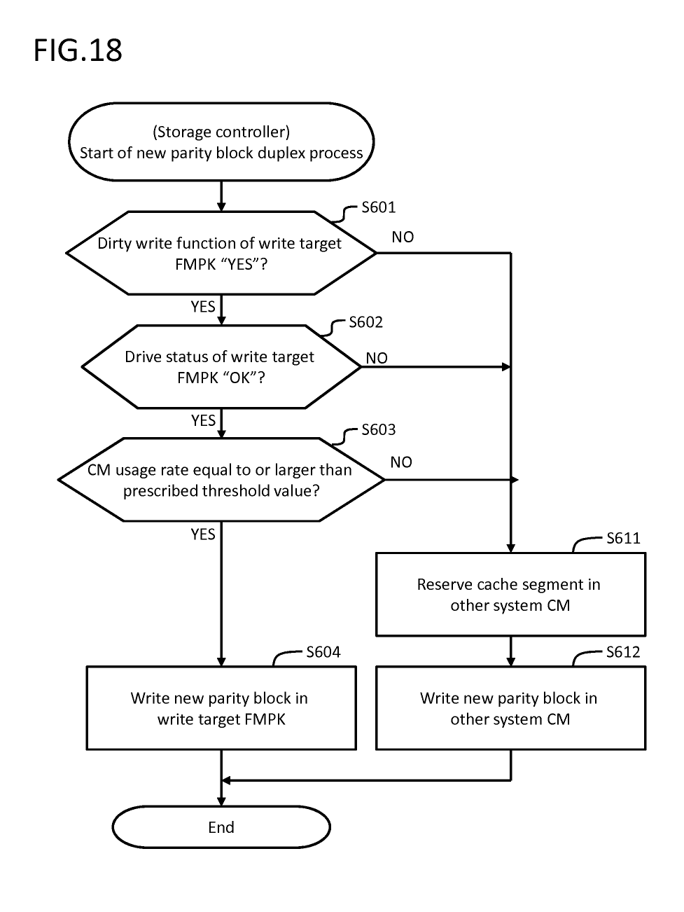

FIG. 18 is a flowchart of the new parity block duplex process performed by the storage controller 10.

The storage controller 10 determines whether or not the dirty write function 203 of an FMPK 20 being a write target is “YES” in reference to the drive configuration information 44 (S601). Herein, it is assumed that the drive of the write target is the FMPK 20.

In a case where the dirty write function 203 of the FMPK 20 being the write target is “YES” (S601: YES), the storage controller 10 determines whether or not the drive status 204 of the FMPK 20 being the write target is “OK” in reference to the drive configuration information 44 (S602).

In a case where the drive status 204 of the FMPK 20 being the write target is “OK” (S602: YES), the storage controller 10 determines whether or not the CM usage rate is equal to or larger than a prescribed threshold value (S603).

In a case where the CM usage rate is equal to or larger than the prescribed threshold value (S603: YES), the storage controller 10 writes the new parity block in the FMPK 20 being the write target (S604), and terminates the process. That is, the storage controller 10 stores (duplexes) the new parity block at two places of the CM 13 and the FMPK 20.

On the other hand, in a case where the dirty write function 203 of the FMPK 20 being the write target is “NO” (S601: NO), in a case where the drive status 204 of the FMPK 20 being the write target is “NG” (S602: NO), or in a case where the CM usage rate is less than the prescribed threshold value (S603: NO), the storage controller 10 reserves a cache segment in other system CM 13 (S611). Then, the storage controller 10 stores the new parity block in the reserved cache segment (S612), and terminates the process. That is, the storage controller 10 stores (duplexes) the new parity block at two places of the self-system CM 13 and the other system CM 13.

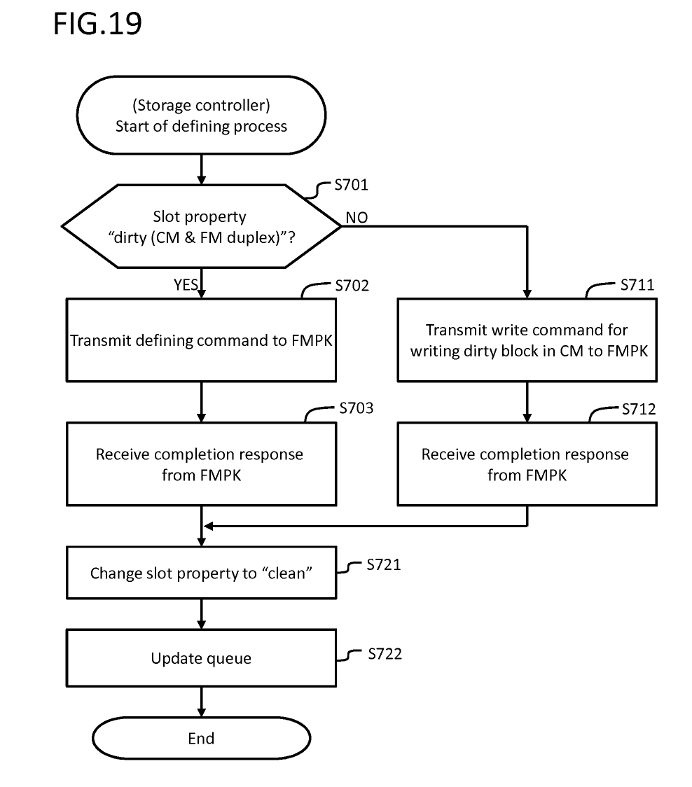

FIG. 19 is a flowchart of a dirty defining process performed by the storage controller 10. The dirty defining means that a dirty block is changed to a formal data block in the FMPK 20 as described above.

The storage controller 10 determines whether or not the slot property 66 of an SGCB 42 of a process target is “dirty (CM & FM duplex)” (S701).

In a case where the slot property 66 is “dirty (CM & FM duplex)” (S701: YES), the storage controller 10 transmits a defining command of a dirty block to the FMPK 20 (S702). This defining command is a command of indicating the FMPK 20 to formally store the dirty block held on the FMPK 20. More specifically, this defining command is a command of indicating to manage a data block managed as a dirty physical page (physical page number 303) on the FMPK 20 as a common physical page (physical page number 302 or a physical page where a physical page storing the data block is not a dirty physical page). Then, when receiving a completion response to the defining command from the FMPK 20 (S703), the storage controller 10 proceeds to Step S721.

On the other hand, in a case where the slot property 66 is not “dirty (CM & FM duplex) (S701: NO), the storage controller 10 transmits a write command for writing the dirty block on the CM 13 in the FMPK 20 as a formal data block (S711). Then, when receiving a completion response to the write command from the FMPK 20 (S712), the storage controller 10 proceeds to Step S721.

Next, the storage controller 10 changes the slot property 66 of the SGCB 42 of the process target to “clean” (S721). Then, the storage controller 10 updates the queue (linked list) (S722), and terminates the process.

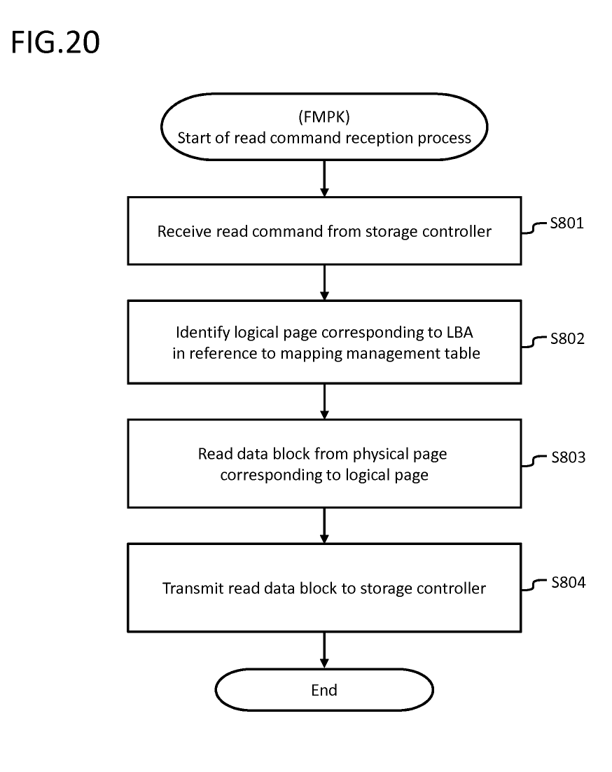

FIG. 20 is a flowchart of a read command reception process performed by the FMPK 20. The main component of the process is the FMPK 20 in the following description, but may be the FM controller 21 or the CPU 72 that the FMPK 20 has.

When receiving a read command from the storage controller 10 (S801), the FMPK 20 performs the following processes. The read command may include an LBA showing a start point of a data block of a read target, and the size of the data block that is desired to be read from the LBA. The read command may be associated with the address of a logical page and the number of the FMPK 20.

The FMPK 20 identifies a logical page corresponding to the LBA in reference to the mapping management table 81 (S802). The FMPK 20 reads a data block from a physical page corresponding to the logical page (S803). The FMPK 20 includes the read data block in a completion response of the read command to transmit the same to the storage controller 10 (S804), and terminates the process.

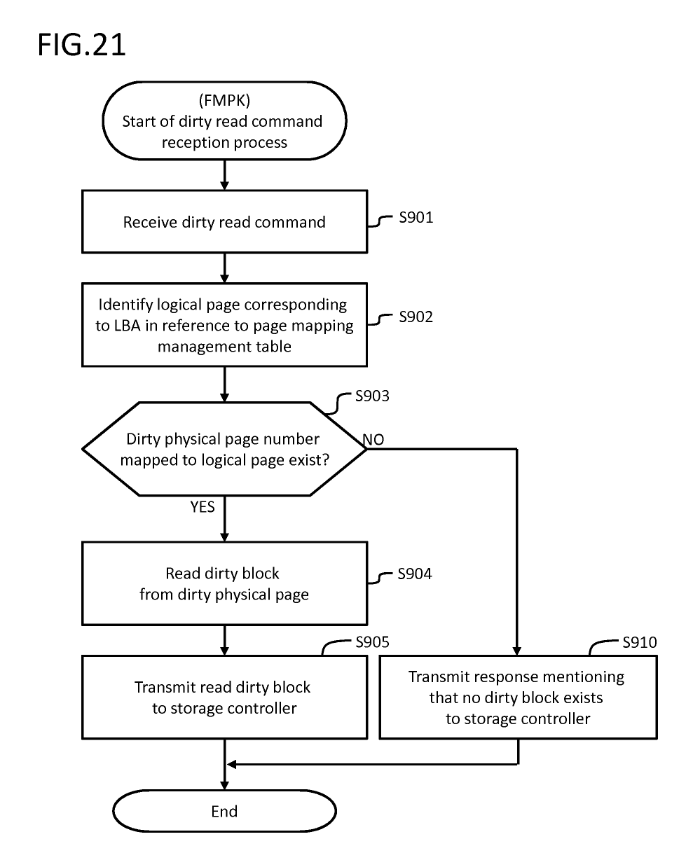

FIG. 21 is a flowchart of a dirty read command reception process performed by the FMPK 20.

When receiving a dirty read command from the storage controller 10 (S901), the FMPK 20 performs the following processes. The dirty read command may include an LBA showing a start point of a dirty block of a read target, and the size of the dirty block that is desired to be read from the LBA. The dirty read command may be associated with the address of a logical page and the number of the FMPK 20.

The FMPK 20 identifies a logical page corresponding to the LBA in reference to the mapping management table 81 (S902). Then, the FMPK 20 determines whether or not a value is stored in a |dirty physical page number 302|[A9] mapped to the logical page, in reference to the mapping management table 81 (S903).

In a case where the value is stored in the |dirty physical page number 302|[A10] (S903: YES), the FMPK 20 reads a dirty block from a physical page showing the value of the |dirty physical page number 302|[A11] (S904). Then, the FMPK 20 includes the read dirty block in a completion response of the dirty read command to transmit the same to the storage controller 10 (S905), and terminates the process.

On the other hand, in a case where the value is not stored in the |dirty physical page number 302|[A12] (i.e., “NULL”) (S903: NO), the FMPK 20 transmits, to the storage controllers 10, a dirty read command completion response mentioning that no dirty block corresponding to the logical page exists (S910), and terminates the process.

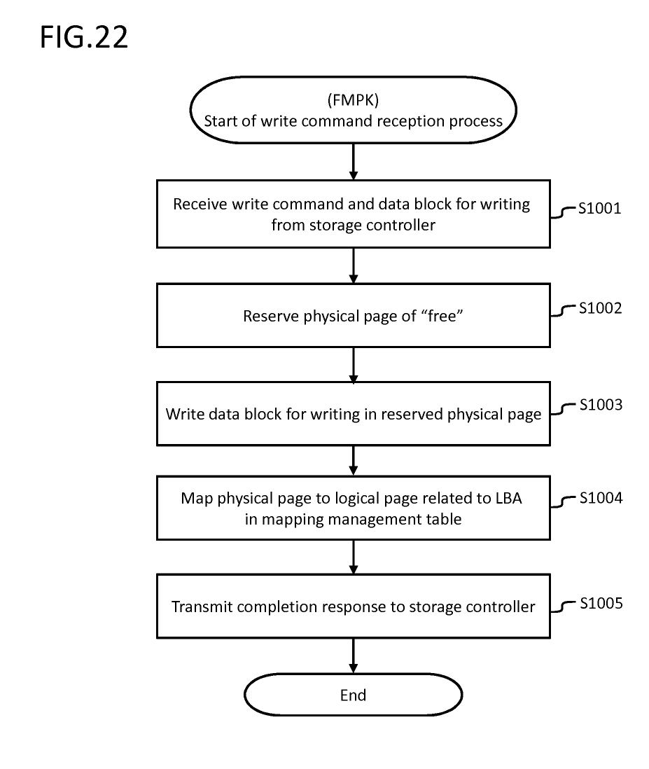

FIG. 22 is a flowchart of a write command reception process performed by the FMPK 20.

When receiving a write command and a data block for writing from the storage controller 10 (S1001), the FMPK 20 performs the following processes. The write command may include an LBA showing a start point of “write”, and the size of the data block for writing. The write command may be associated with the address of a logical page and the number of the FMPK 20.

The FMPK 20 reserves a physical page of “free” for storing the data block for writing (S1002). The FMPK 20 writes the data block for writing in the reserved physical page of “free” (S1003).

The FMPK 20 identifies a logical page number 301 corresponding to the LBA in the mapping management table 81 to store, in a physical page number 302 corresponding to the logical page number 301, a number (value) showing the physical page where the data block for writing is written (S1004).

The FMPK 20 transmits a write command completion response to the storage controller 10 (S1005), and terminates the process.

FIG. 23 is a flowchart of a dirty write command reception process performed by the FMPK 20.

When receiving a dirty write command from the storage controller 10 (S1101), the FMPK 20 performs the following processes. The dirty write command may include an LBA showing a start point of “write”, and the size of a dirty block. The dirty write command may be associated with the address of a logical page and the number of the FMPK 20. Herein, the dirty write command is a command of storing a data block on the FMPK 20 as an undefined state, and is often referred to as an undefining write command.

The FMPK 20 identifies a logical page corresponding to the LBA in reference to the mapping management table 81 (S1102). The FMPK 20 determines whether or not a value is already stored in a |dirty physical page number 302|[A13] corresponding to the logical page (S1103).

In a case where the value is not stored in the |dirty physical page number 302|[A14] (i.e., “NULL”) (S1103: NO), the FMPK 20 proceeds to Step S1105.

In a case where the value is already stored in the |dirty physical page, number 302|[A15] (S1103: YES), the FMPK 20 changes the |dirty physical page number 302|[A16] to “NULL” in the mapping management table 81 (S1104), and proceeds to Step S1105.

Next, the FMPK 20 reserves a dirty physical page of “free” for storing a dirty block (S1105). The FMPK 20 writes the dirty block in the reserved dirty physical page of “free” (S1106).

The FMPK 20 identifies a logical page number 301 corresponding to the LBA in the mapping management table 81 to store, in a |dirty physical page number 302|[A17] corresponding to the logical page number 301, a number (value) showing the physical page where the dirty block is written (S1107).

The FMPK 20 updates the queue (linked list) (S1108). The FMPK 20 transmits a completion response of the dirty write command to the storage controller 10 (S1109), and terminates the process. Thus, in a case of receiving a dirty write command of a certain logical page, the FMPK 20 stores the received data block thereon as a dirty physical page (i.e., as an undefined state) while holding the data block mapped to the logical page as a physical page.

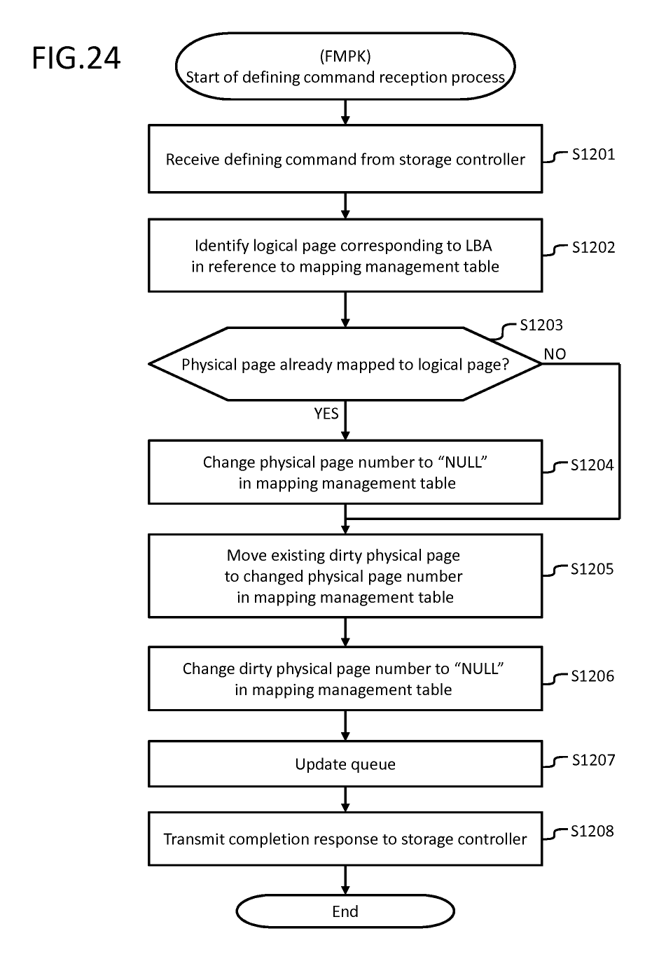

FIG. 24 is a flowchart of a dirty defining command reception process of the FMPK 20.

When receiving a dirty block defining command from the storage controller 10 (S1201), the FMPK 20 performs the following processes. The dirty block defining command may include an LBA showing a dirty block that is desired to be defined. The dirty block defining command may be associated with the address of a logical page and the number of the FMPK 20.

The FMPK 20 identifies a logical page corresponding to the LBA in reference to the mapping management table 81 (S1202). The FMPK 20 determines whether or not a value is already stored in a physical page number 302 corresponding to the logical page, (S1203).

In a case where the value is not stored in the physical page number 302 (i.e., “NULL”) (S1203: NO), the FMPK 20 proceeds to Step S1205.

In a case where the value is already stored in the physical page number 302 (S1203: YES), the FMPK 20 changes the physical page number 302 to “NULL” in the mapping management table 81 (S1204), and proceeds to Step S1205.

Next, the FMPK 20 moves the value of an existing |dirty physical page number 302|[A18] to the physical page number 302 (S1205) in the mapping management table 81. The FMPK 20 changes the |dirty physical page number 302|[A19] to “NULL” in the mapping management table 81 (S1206).

The FMPK 20 updates the queue (linked list) (S1207). The FMPK 20 transmits a completion response to the defining command to the storage controller 10 (S1208), and terminates the process.

FIG. 25 is a flowchart of a dirty block discard command reception process of the FMPK 20.

When receiving a dirty block discard command from the storage controller 10 (S1301), the FMPK 20 performs the following processes. The dirty block discard command may include an LBA showing a dirty block that is desired to be discarded. The dirty block discard command may be associated with the address of a logical page and the number of the FMPK 20.

The FMPK 20 identifies a logical page corresponding to the LBA in reference to the mapping management table 81 (S1302). The FMPK 20 changes a |dirty physical page number 302|[A20] mapped to the logical page to “NULL” in the mapping management table 81 (S1303).

The FMPK 20 updates the queue (linked list) (S1304). The FMPK 20 transmits, to the storage controller 10, a response mentioning that the process of the dirty discard command is completed (S1305), and terminates the process.

The storage system 1 according to this embodiment duplexes a dirty block by “CM & FM duplex”, so that an I/O load to the CM 13 can be further reduced compared to a case where the dirty block is duplexed by “CM duplex”.

Additionally, the storage system 1 properly switches between “CM & FM duplex” and “CM duplex” on the basis of the CM usage rate, so that response performance to the host 2 can be maintained or improved. This is because in a case where the CM usage rate is high (the I/O load to the CM 13 is high), when the CM duplex is performed, a waiting time until a dirty block is written in the CM 13 is generated. That is, the writing speed of the FM 77 is sufficiently fast, and therefore a total writing process time in a case where the dirty block is written in the CM 13 where the CM usage rate is high is sometimes shorter than a total writing process time in a case where the dirty block is written in the FM 77.

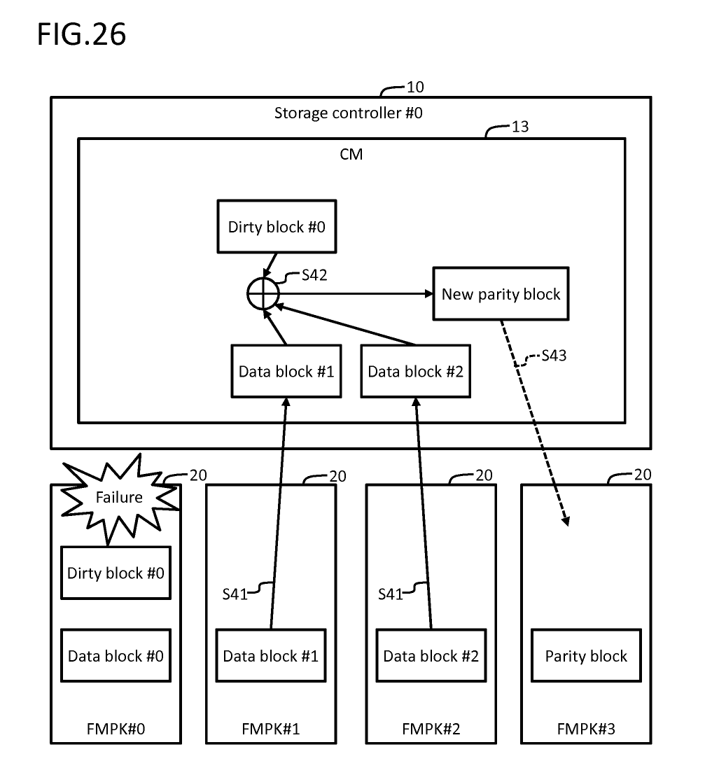

FIG. 26 is a figure for illustrating a dirty block duplex process performed in a case where a failure occurs on the FMPK 20#0.

In FIG. 26, the FMPK 20#0 stores a data block #0, the FMPK 20#1 stores a data block #1, the FMPK 20#2 stores a data block #2, and the FMPK 20#3 stores a parity block. This parity block is created from the data blocks #0 to #2. A dirty block #0 is duplexed in the CM 13 and the FMPK 20#0.

Herein, in a case where a failure occurs on the FMPK 20#0, the dirty block #0 and the data block #0 which are stored in the FMPK 20#0 are lost. However, the dirty block #0 exists also in the CM 13. Additionally, the dirty block #0 can be recovered from the data block #1, the data block #2, and the parity block. Accordingly, in the whole of the storage system, the dirty block #0 and the data block #0 are not lost.

However, the dirty block #0 exists at only one place of the CM 13, and therefore prompt redundancy is required. This redundant process will be hereinafter shown.

The storage controller 10 reads the data blocks #1 and #2 from the FMPKs 20#1, #2 in the CM 13, respectively (S41). The storage controller 10 creates a new parity block from these data blocks #1 and #2, and the dirty block #0 stored in the CM 13 (S42). The storage controller 10 writes a new parity block in, for example, the FMPK 20#3 (S43). Through the above processes, the dirty block #0 is made redundant.

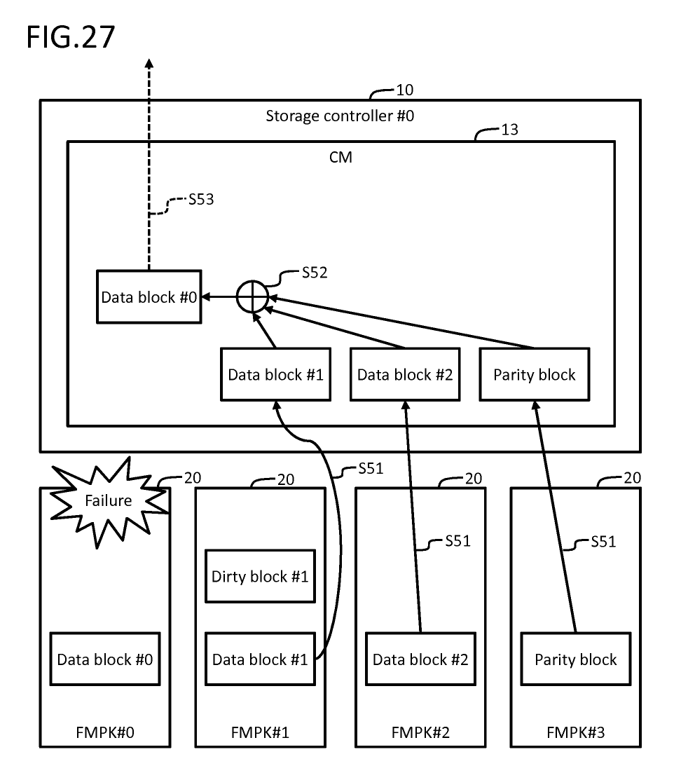

FIG. 27 is a figure for illustrating a read command process performed by the storage controller 10 in a case where a failure occurs on the FMPK 20#0.

In FIG. 27, the FMPK 20#0 stores a data block #0, the FMPK 20#1 stores a data block #1, the FMPK 20#2 stores a data block #2, and the FMPK 20#3 stores a parity block. This parity block is created from the data blocks #0 to #2. The FMPK 20#1 has a dirty block #1 having the correspondence relation with the data block #1 in a logical page.

Herein, it is assumed that the storage controller 10 receives a read command of the data block #0 from the host 2 in a state where a failure occurs on the FMPK 20#0. In this case, the storage controller 10 cannot read the data block #0 from the FMPK 20#0. Accordingly, the storage controller 10 performs the following processes.

The storage controller 10 reads the data block #1, the data block #2, and the parity block from the FMPK 20#1 to #3 in the CM 13, respectively (S51). At this time, although the FMPK 20#1 stores the dirty block #1, the storage controller 10 does not read the dirty block #1, but reads the data block #1 from the FMPK 20#1. The storage controller 10 recovers the data block #0 from the data block #1, the data block #2, and the parity block (S52). The storage controller 10 returns the recovered data block #0 to the host 2 as a response of the read command (S53). Through the above processes, even in a case where a failure occurs on a certain FMPK 20, the storage controller 10 can recover the data block stored in the FMPK 20.

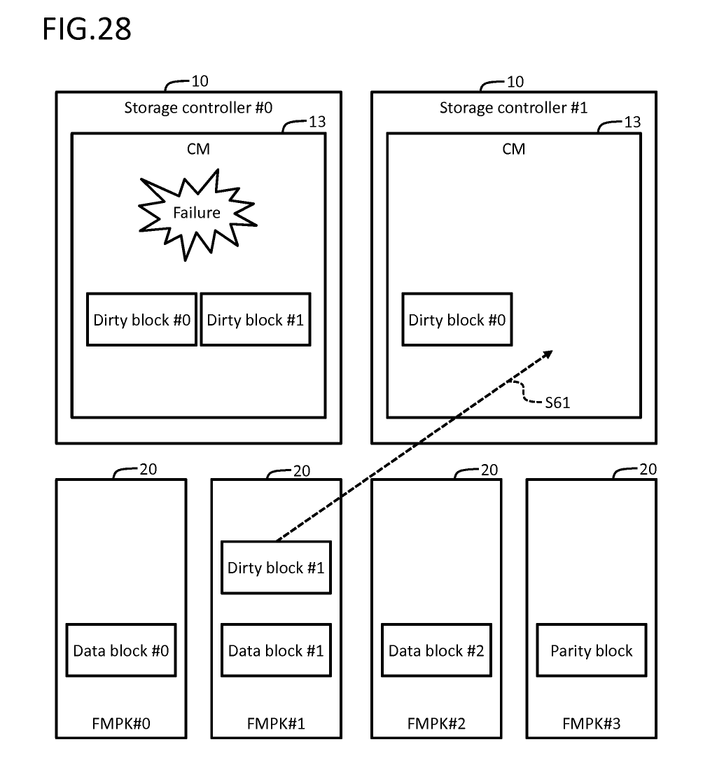

FIG. 28 is a figure for illustrating a dirty block duplex process performed in a case where a failure occurs on the storage controller 10#0.

In FIG. 28, the FMPK 20#0 stores a data block #0, the FMPK 20#1 stores a data block #1, the FMPK 20#2 stores a data block #2, and the FMPK 20#3 stores a parity block. This parity block is created from the data blocks #0 to #2. A dirty block #0 is duplexed in the CM 13 of the storage controller 10#0 and the CM 13 of the storage controller 10#1. The dirty block #1 is duplexed in the CM 13 of the storage controller 10#0 and the FMPK 20#1.

Herein, it is assumed that a failure occurs on the storage controller 10#0. In this case, the dirty blocks #0 and #1 each are one, and therefore prompt redundancy is required. The redundant process of the data block #0 is shown in FIG. 26. A process of making the dirty block stored in the FMPK 20 (dirty block #1 in FIG. 28) redundant in such a case will be now described.

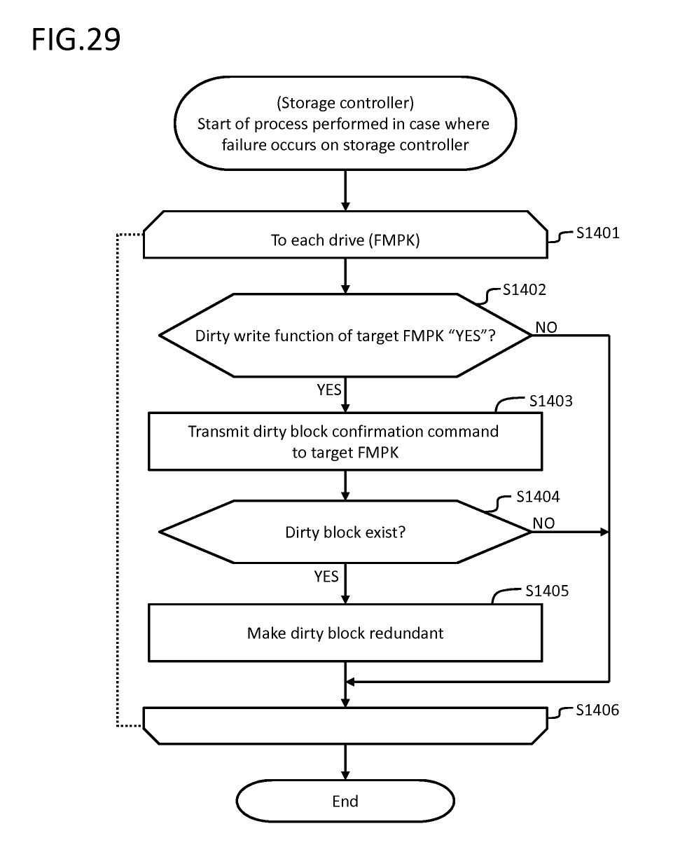

FIG. 29 is a flowchart of a process performed in a case where a failure occurs on the storage controller 10. This process is performed by another storage controller 10 on which no failure occurs.

The storage controller 10 performs the following processes in Step S1402 to S1405 for each of the drives stored in the drive enclosure 3 (S1401). In the following description, it is assumed that each drive is the FMPK 20.

The storage controller 10 determines whether or not a dirty write function 203 of an FMPK 20 of a target of this loop process (hereinafter referred to as “target FMPK”) is “YES” in reference to the mapping management table 81 (S1402).

In a case where the dirty write function 203 of the target FMPK 20 is “NO” (S1402: NO), the storage controller 10 proceeds to Step S1406. This is because no dirty block exists on this target FMPK 20.

In a case where the dirty write function 203 of the target FMPK 20 is “YES” (S1402: YES), the storage controller 10 transmits a dirty block confirmation command to the target FMPK 20 (S1403). That is, the storage controller 10 confirms whether or not a dirty block exists in the target FMPK 20 by the dirty block confirmation command. The details of this dirty block confirmation command will be described later. In a case where the dirty block exists, the storage controller 10 receives an LBA stored in the dirty block. In a case where no dirty block exists, the storage controller 10 receives a response of “NULL”.

The storage controller 10 confirms the response of the dirty block confirmation command to determine whether or not the dirty block exists in the target FMPK 20 (S1404).

In a case of determining that no dirty block exists in the target drive (S1404: NO), the storage controller 10 proceeds to Step S1406.

In a case of determining that the dirty block exists in the target drive (S1404: YES), the storage controller 10 make this dirty block redundant (S1405), and proceeds to Step S1406. The storage controller 10 may create a new parity block as shown in FIG. 26 to make this dirty block redundant, or may copy this dirty block in its own CM 13 to duplex the same.

The storage controller 10 determines whether or not an unprocessed FMPK 20 remains. In a case where the unprocessed FMPK 20 remains, the storage controller 10 returns to Step S1401. In a case where no unprocessed FMPK 20 remains, the storage controller 10 gets out of this loop process to terminate the process (S1406).

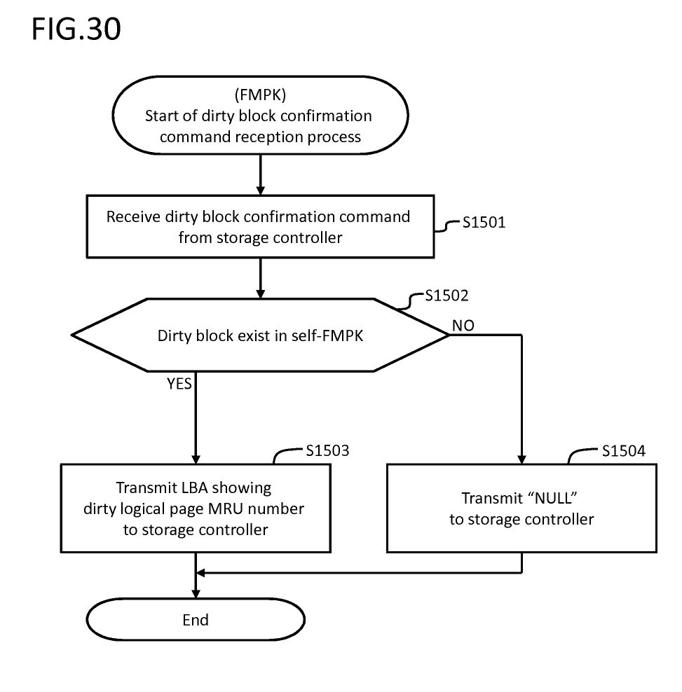

FIG. 30 is a flowchart of a dirty block confirmation command reception process performed by the FMPKs 20.

When receiving a dirty block confirmation command from the storage controller 10 (S1501), the FMPK 20 performs the following processes.

The FMPK 20 determines whether or not a dirty block exists in its own FMPK 20 in reference to the dirty page management information 82 (S1502). For example, the determination is made on the basis of whether or not the dirty logical page MRU number 401 is “NULL”.

In a case where no dirty block exists (S1502: NO), the FMPK 20 returns “NULL” to the storage controller 10 as a response to the dirty block confirmation command (S1604), and terminates the process.

In a case where the dirty block exists (S1502: YES), the FMPK 20 returns an LBA showing a dirty logical page MRU number to the storage controller 10 as a response to the dirty block confirmation command (S1503), and terminates the process.

The storage controller 10 that receives the LBA showing the dirty logical page MRU number 401 to trace this linked list, so that each data block can be read to be made redundant.

### Second Embodiment

In a second embodiment, processes performed in a case where a storage system 1b includes only one storage controller 10 will be described.

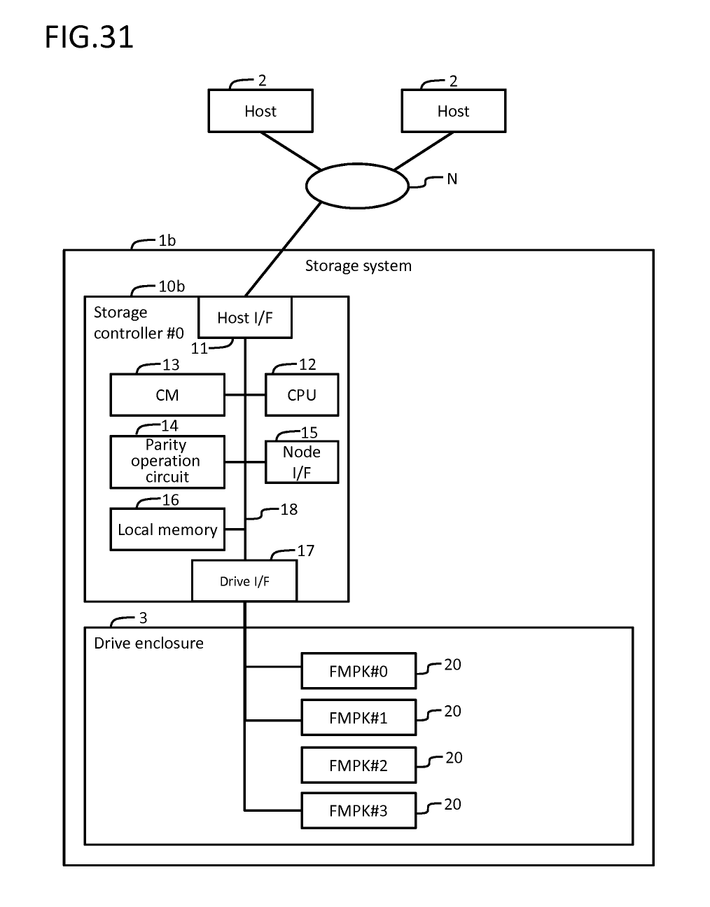

FIG. 31 is a block diagram showing a whole configuration of a storage system 1b according to the second embodiment. The storage system 1b according to the second embodiment is similar to the storage system 1 according to the first embodiment except that the storage system 1b includes only one storage controller 10. Hereinafter, processes performed by the storage system 1b in a case where a write command is received from a host 2 in the second embodiment will be described.

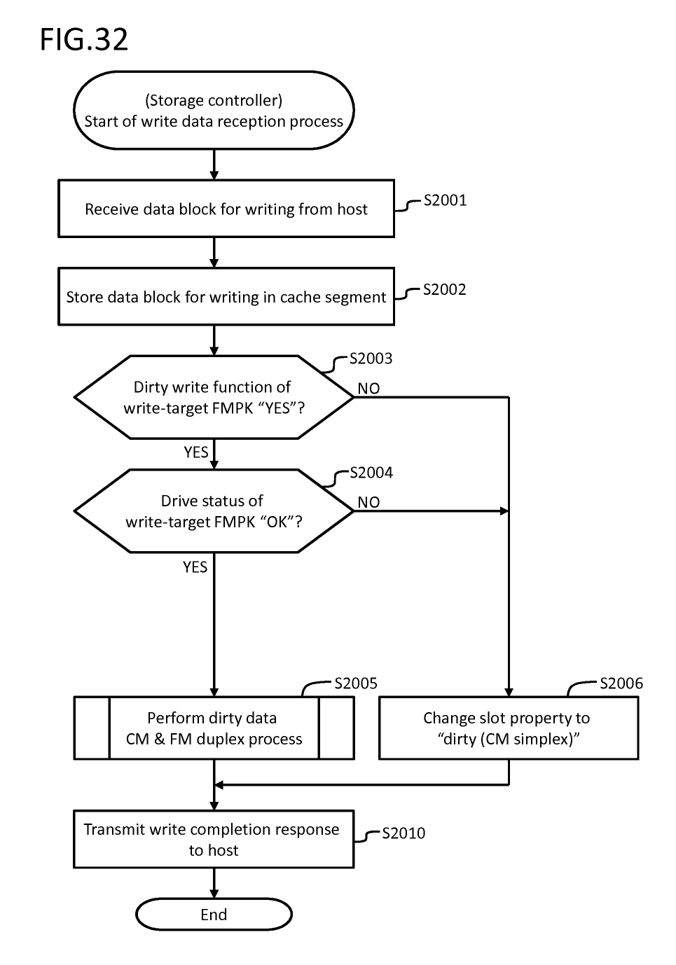

FIG. 32 is a flowchart of a write data reception process performed by a storage controller 10b according to the second embodiment. The write command reception process will be similar to that shown in FIG. 13.

When receiving a data block for writing from the host 2 (S2001), the storage controller 10b performs the following processes. The storage controller 10b stores the data block for writing in a cache segment reserved on a CM 13 (S2002).

The storage controller 10 determines whether or not the dirty write function 203 of an FMPK 20 (drive) of a write target is “YES” in reference to a dirty write function 203 in drive configuration information 44 (S2003).

In a case where the dirty write function 203 of the target FMPK 20 is “YES” (S2003: YES), the storage controller 10b determines whether or not the drive status 204 of the target FMPK 20 is “OK” in reference to a drive status 204 in the drive configuration information 44 (S2004).

In a case where the drive status 204 of the target FMPK 20 is “OK” (S2004: YES), the storage controller 10 determines that the data block for writing is cached at two places of the CM 13 and the FMPK 20 (CM & FM duplex), and performs a “dirty data CM & FM duplex process” (S2005). The “dirty data CM & FM duplex process” is similar to that shown in FIG. 15. Then, the storage controller 10 returns a completion response of the write command to the host 2 (S2010), and terminates the process.

On the other hand, in a case where the dirty write function 203 of the target FMPK 20 is “NO” (S2003: NO), or in a case where the drive status 204 of the target FMPK 20 is “NO” (S2004: NO), the storage controller 10 determines that the data block for writing is cached at one place of the self-system CM 13 (CM simplex), and the slot property 66 of a corresponding SGCB 42 is changed to “dirty (CM simplex)” (S2006). Then, the storage controller 10 returns the write command completion response to, the host 2 (S2010), and terminates the process.

According to the second embodiment, in the storage system that has only one CM 13 (has only one storage controller), a data block can be duplexed to be cached. That is, according to the second embodiment, fault tolerance in the storage system that has only one CM 13 can be enhanced.

The aforementioned embodiments are exemplification, and the scope of the present invention is not limited only to these embodiments. A person in skilled in the art can practice the present invention in various aspects without departing the spirit and scope of the present invention.

For example, other types of storage devices may be employed in place of the FMPKs 20. The storage device may have a non-volatile memory (storage medium) configured by a plurality of physical areas, and a medium controller for accessing the non-volatile memory according to a request from the storage controller.

The medium controller may provide an upper class device like the storage controller with a plurality of logical areas. The medium controller may assign the physical area to a logical area being a write destination designated from the upper class device, and write data of a write target in the assigned physical area. The medium controller may assign a first class physical area and a second class physical area to the same logical area. The first class physical area may be a storage area as a final storage destination for data (storage destination for data of a destaged target (clean data)), and an example thereof may be a physical page in a defined state (clean). The second class physical area may be a storage area as a storage destination for cache data, and an example thereof may be a physical page in an undefined state (dirty).

The non-volatile memory may be a recordable memory where overwriting is not enabled. That is, both the first class physical area and the second class physical area may not enable overwriting of data.

Specifically, in a case where a first physical area is assigned to a logical area of a destaging destination, the medium controller may assign an empty physical area to the logical area of the destaging destination in place of the already assigned first class physical area, and may write data of a destaged target in the assigned empty physical area. In this case, data stored in the already assigned first class physical area may become invalid data (data older than valid data) from valid data (data recently stored in the destaging destination logical area), and data stored in a physical area newly assigned in the destaging destination logical area may become valid data for the destaging destination logical area. Similarly, in a case where the second class physical area is assigned to a logical area of a cache destination, the medium controller may assign an empty physical area to the logical area of the cache destination in place of the already assigned second class physical area, and may write data of a cache target in the assigned empty physical area. In this case, data stored in the already assigned second class physical area may become invalid data (data older than valid data) from valid data (data recently stored in the cache destination logical area), and data stored in a physical area newly assigned in the cache destination logical area may become valid data for the cache destination logical area.

### REFERENCE SIGNS LIST

1, 1b Storage system
2 Host
10, 10b Storage controller
13 CM (Cache memory)
20 FMPK (Flash memory package)
81 Mapping management table

1. A storage system comprising:
a storage controller having a first cache memory, and configured to receive a write command of a data block; and
a storage device having a non-volatile memory configured by a plurality of physical areas, the storage device being configured to provide a plurality of logical areas including a target logical area corresponding to a write destination in accordance with the write command, wherein
the storage controller is configured to:
store a data block related to the received write command in the first cache memory as an undefined state; and
transmit, to the storage device, an undefining write command of requesting to store the data block as an undefined state, the undefining write command being a command associated with an address of the target logical area, and
the storage device is configured to receive the undefining write command from the storage controller, store a data block related to the undefining write command in an empty physical area of the plurality of physical areas, and assign the physical area to the target logical area as a physical area in an undefined state.

2. The storage system according to claim 1, wherein
the storage controller is configured to transmit, to the storage device, a defining command of requesting to change a data block in an undefined state to a defined state, and designating the address of the target logical area, and
the storage device is configured to receive the defining command from the storage controller, and change the physical area in the undefined state, which is assigned to the target logical area, to a physical area in the defined state.

3. The storage system according to claim 2, wherein
in a case of newly receiving the undefining write command of designating the address of the target logical area, to which the physical area in the defined state is assigned, the storage device is configured to store a data block related to the newly received undefining write command in an empty physical area of the plurality of physical areas, and assign the physical area as a physical area in an undefined state to the target logical area, to which the physical area in the defined state is assigned.

4. The storage system according to claim 3, wherein
the storage device is configured to store management information for managing correspondence relation among the logical areas, the physical area in the undefined state, and the physical area in the defined state, and
the storage system is configured to update the management information according to change of the physical area in the defined state or change of the physical area in the undefined state assigned to the logical area.

5. The storage system according to claim 2, wherein
the storage controller is configured to:
create a redundant block for ensuring redundancy of a data block, which is stored in the storage device; and
transmit the defining command to the storage device after storing the redundant block in the storage device.

6. The storage system according to claim 5, wherein
the defining command is a command of requesting to change, to a defined state, a data block in an undefined state, which is used for creating the redundant block.

7. The storage system according to claim 1, wherein
the storage controller is configured to transmit, to the storage device, an undefining read command of requesting to read the data block in the undefined state, and designating the address of the target logical area, and
the storage device is configured to receive the undefining read command from the storage controller, and read the data block stored in the physical area in the undefined state, which is assigned to the target logical area.

8. The storage system according to claim 1, wherein
the storage controller is configured to transmit, to the storage device, a defining read command of requesting to read the data block in the defined state, and designating the address of the target logical area, and
the storage device is configured to receive the defining read command from the storage controller, and read the data block stored in the physical area in the defined state, which is assigned to the target logical area.

9. The storage system according to claim 8, wherein
in a case where a failure occurs on a certain storage device, the storage controller is configured to read a prescribed data block and a redundant block from a storage device where no failure occurs, by using the defining read command, and recover a data block stored in the storage device where the failure occurs.

10. The storage system according to claim 8, wherein
in a case where a failure occurs on a certain storage device, the storage controller is configured to read a prescribed data block from a storage device where no failure occurs, by using the defining read command, and create a new redundant block by using the prescribed data block and the data block in the undefined state, which is stored in the first cache memory.

11. The storage system according to claim 1, further comprising
a second cache memory, wherein
in a case of receiving the write command, the storage controller is configured to determine, on the basis of a prescribed condition, whether the data block related to the write command:
A) is stored in the first cache memory and the second cache memory as an undefined state; or
B) is stored in either the first cache memory or the second cache memory as an undefined state, and the undefining write command is transmitted to the storage device.

12. The storage system according to claim 11, wherein
the prescribed condition is based on a load of input/output of the data block to/from the first cache memory or the second cache memory, and the storage controller is configured to determine as the A) in a case where the load is less than a prescribed threshold value, and determine as the B) in a case where the load is equal to or larger than the prescribed threshold value.

13. A control method for a storage controller having a first cache memory and configured to receive a write command of a data block, and for a storage device having a non-volatile memory configured by a plurality of physical areas, the storage device being configured to provide a plurality of logical areas including a target logical area corresponding to a write destination in accordance with the write command, the control method comprising the steps of:
operating the storage controller to store a data block related to the received write command in the first cache memory as an undefined state;
operating the storage controller to transmit, to the storage device, an undefining write command of requesting to store the data block as an undefined state, the undefining write command being a command associated with an address of the target logical area; and
operating the storage device to receive the undefining write command from the storage controller, store a data block related to the undefining write command in an empty physical area of the plurality of physical areas, and assign the physical area to the target logical area as a physical area in an undefined state.
